(19) United States
(12) Patent Application Publication
(10) Pub. No.: US 2025/0008607 A1
(43) Pub. Date: Jan. 2, 2025

(54) TECHNIQUES FOR PERFORMING COMMUNICATIONS WHILE IN A FLYING STATE

(71) Applicant: QUALCOMM Incorporated, San Diego, CA (US)

(72) Inventors: Umesh PHUYAL, San Diego, CA (US); Stefano FACCIN, San Ysidro, CA (US); Haris ZISIMOPOULOS, London (GB); Chiranjib SAHA, Lakeside, CA (US); Le LIU, San Jose, CA (US); Alberto RICO ALVARINO, San Diego, CA (US)

(21) Appl. No.: 18/707,519

(22) PCT Filed: Nov. 18, 2022
(86) PCT No.: PCT/US2022/080132

§ 371 Date: May 3, 2024

(30) Foreign Application Priority Data
Jan. 7, 2022 (GR) 20220100007

(51) Int. Cl. H04W 76/50; H04W 4/90

(52) U.S. Cl. CPC H04W 76/50; H04W 4/90

(57) ABSTRACT

Methods, systems, and devices for wireless communications are described. A user equipment (UE) may be aboard an aerial vehicle such that the UE is above ground, and in some cases, moving above ground (e.g., flying). The UE may determine to perform an emergency communication procedure (e.g., an emergency call) while the UE meets one or more flying state conditions, where the one or more flying state conditions may be indicative that the UE is in a flying state. The UE may transmit a message to a base station as part of the emergency communication procedure, where the message may be indicative that the UE meets the one or more flying state conditions. The UE may participate in the emergency communication procedure while the UE is in the flying state.

### CROSS REFERENCES

The present application for patent is a 371 national stage filing of International PCT Application No. PCT/US2022/080132 by PHUYAL et al., entitled “TECHNIQUES FOR PERFORMING COMMUNICATIONS WHILE IN A FLYING STATE,” filed Nov. 18, 2022; and claims priority to Greek patent application No. 20220100007 by PHUYAL et al., entitled “TECHNIQUES FOR PERFORMING COMMUNICATIONS WHILE IN A FLYING STATE,” filed Jan. 7, 2022, each of which is assigned to the assignee hereof, and each of which is expressly incorporated by reference in its entirety herein.

### FIELD OF TECHNOLOGY

The following relates to wireless communications, including techniques for performing communications while in a flying state.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations or one or more network access nodes, each simultaneously supporting communication for multiple communication devices, which may be otherwise known as user equipment (UE).

In some wireless communication systems, a user equipment (UE) may be aboard an aerial vehicle (e.g., a passenger of the aerial vehicle) such that the UE is above ground, and in some cases, moving above ground (e.g., flying, in a flying state). The UE may determine to perform an emergency call with a base station while the UE is in the flying state. Techniques for performing such an emergency call while the UE is in a flying state may be improved.

### SUMMARY

The described techniques relate to improved methods, systems, devices, and apparatuses that support techniques for performing communications while in a flying state. Generally, the described techniques provide for improved methods for a user equipment (UE), or some other aerial device to participate in an emergency call while the UE is aboard (e.g., a passenger of) an aerial vehicle (e.g., an unmanned aerial vehicle (UAV), an un-crewed aerial vehicle, a low-altitude flying vehicle, etc.). The UE may determine to perform an emergency communication procedure while the UE meets one or more flying state conditions indicative that the UE is in a flying state. The UE may transmit a message to a base station as part of the emergency communication procedure, where the message may be indicative that the UE meets the one or more flying state conditions. The UE may participate in the emergency communication procedure while the UE is in the flying state based on the transmitted message and the indication that the UE meets the one or more flying state conditions.

A method for wireless communications at a UE is described. The method may include determining to perform an emergency communication procedure while the UE meets one or more flying state conditions indicative that the UE is in a flying state, transmitting a message to a base station as part of the emergency communication procedure, the message indicative that the UE meets the one or more flying state conditions, and participating in the emergency communication procedure while the UE is in the flying state.

An apparatus for wireless communications at a UE is described. The apparatus may include a processor, and a memory coupled with the processor, where the memory includes instructions executable by the processor to cause the apparatus to determine to perform an emergency communication procedure while the UE meets one or more flying state conditions indicative that the UE is in a flying state, transmit a message to a base station as part of the emergency communication procedure, the message indicative that the UE meets the one or more flying state conditions, and participate in the emergency communication procedure while the UE is in the flying state.

Another apparatus for wireless communications at a UE is described. The apparatus may include means for determining to perform an emergency communication procedure while the UE meets one or more flying state conditions indicative that the UE is in a flying state, means for transmitting a message to a base station as part of the emergency communication procedure, the message indicative that the UE meets the one or more flying state conditions, and means for participating in the emergency communication procedure while the UE is in the flying state.

A non-transitory computer-readable medium storing code for wireless communications at a UE is described. The code may include instructions executable by a processor to determine to perform an emergency communication procedure while the UE meets one or more flying state conditions indicative that the UE is in a flying state, transmit a message to a base station as part of the emergency communication procedure, the message indicative that the UE meets the one or more flying state conditions, and participate in the emergency communication procedure while the UE is in the flying state.

In some examples of the method, apparatuses, and non-transitory computer-readable medium described herein, transmitting the message may include operations, features, means, or instructions for transmitting a session initiation protocol message in accordance with a user provided location information procedure, where the session initiation protocol message includes an indication that the UE meets the one or more flying state conditions.

In some examples of the method, apparatuses, and non-transitory computer-readable medium described herein, the session initiation protocol message may be an access network information header included in a session initiation protocol.

In some examples of the method, apparatuses, and non-transitory computer-readable medium described herein, transmitting the message may include operations, features, means, or instructions for transmitting an invite to participate in the emergency communication procedure, the invite including an indication that the UE meets the one or more flying state conditions.

In some examples of the method, apparatuses, and non-transitory computer-readable medium described herein, transmitting the message may include operations, features, means, or instructions for transmitting the message to a location retrieval function in accordance with a network provided location information procedure.

In some examples of the method, apparatuses, and non-transitory computer-readable medium described herein, transmitting the message may include operations, features, means, or instructions for transmitting a radio resource control session connection request message including an indication that the UE meets the one or more flying state conditions based on determining to perform the emergency communication procedure.

In some examples of the method, apparatuses, and non-transitory computer-readable medium described herein, transmitting the message may include operations, features, means, or instructions for transmitting a non-access stratum packet data network connection message including an indication that the UE meets the one or more flying state conditions based on determining to perform the emergency communication procedure.

In some examples of the method, apparatuses, and non-transitory computer-readable medium described herein, transmitting the message may include operations, features, means, or instructions for transmitting a medium access control (MAC) control element (MAC-CE) message including an indication that the UE meets the one or more flying state conditions based on determining to perform the emergency communication procedure.

In some examples of the method, apparatuses, and non-transitory computer-readable medium described herein, transmitting the message may include operations, features, means, or instructions for determining that the UE may be in a limited-service state and transmitting a registration message based on determining that the UE may be in the limited-service state, where the registration message includes an indication that the UE meets the one or more flying state conditions based on determining to perform the emergency communication procedure.

In some examples of the method, apparatuses, and non-transitory computer-readable medium described herein, transmitting the message may include operations, features, means, or instructions for determining that the UE lacks an established emergency protocol data unit session and transmitting a protocol data unit session establishment message including a request type, where the request type indicates an emergency request and that the UE meets the one or more flying state conditions.

In some examples of the method, apparatuses, and non-transitory computer-readable medium described herein, transmitting the message may include operations, features, means, or instructions for transmitting the message via a frequency band dedicated to aerial vehicles, where the frequency band indicates that the UE meets the one or more flying state conditions.

In some examples of the method, apparatuses, and non-transitory computer-readable medium described herein, transmitting the message may include operations, features, means, or instructions for transmitting the message to the base station via an aerial vehicle on which the UE may be boarded for a flight.

Some examples of the method, apparatuses, and non-transitory computer-readable medium described herein may further include operations, features, means, or instructions for transmitting an indication of a height of the UE based on the UE meeting the one or more flying state conditions of the flying state.

Some examples of the method, apparatuses, and non-transitory computer-readable medium described herein may further include operations, features, means, or instructions for transmitting information associated with an aerial vehicle on which the UE may be boarded for a flight.

In some examples of the method, apparatuses, and non-transitory computer-readable medium described herein, the information includes a broadcast remote identifier (BRID) of the aerial vehicle, a location of the aerial vehicle, a flight path, a flight number, a flight plan, or a combination thereof.

In some examples of the method, apparatuses, and non-transitory computer-readable medium described herein, the UE determines the information based on proximity to the aerial vehicle, a quick response code associated with the aerial vehicle, location services provided by the aerial vehicle, or a combination thereof.

Some examples of the method, apparatuses, and non-transitory computer-readable medium described herein may further include operations, features, means, or instructions for receiving an indication of whether emergency services for UEs in the flying state may be supported, where participating in the emergency communication procedure may be based on the support indicated.

In some examples of the method, apparatuses, and non-transitory computer-readable medium described herein, the UE receives the indication of support via an Access and Mobility Management Function or a system information block.

Some examples of the method, apparatuses, and non-transitory computer-readable medium described herein may further include operations, features, means, or instructions for receiving, in response to the message and prior to participating in the emergency communication procedure, a request to provide input associated with the flying state.

Some examples of the method, apparatuses, and non-transitory computer-readable medium described herein may further include operations, features, means, or instructions for determining that the UE meets the one or more flying state conditions based on one or more sensors of the UE.

Some examples of the method, apparatuses, and non-transitory computer-readable medium described herein may further include operations, features, means, or instructions for determining that the UE may be abroad an aerial vehicle and determining that the UE meets the one or more flying state conditions based on identifying information associated with the aerial vehicle, where the information includes a flight path, a flight number, a flight plan, or a combination thereof.

Some examples of the method, apparatuses, and non-transitory computer-readable medium described herein may further include operations, features, means, or instructions for receiving, from an aerial vehicle on which the UE may be boarded for a flight, a broadcast message including a flight metric, where the flight metric indicates a benchmark of the flight, a flight identifier, flight plans, or a combination thereof and determining that the UE meets the one or more flying state conditions based on receiving the broadcast message.

A method for wireless communications at a base station is described. The method may include receiving a message as part of an emergency communication procedure, the message associated with a UE, identifying that the UE meets one or more flying state conditions indicative that the UE is in a flying state, and participating in the emergency communication procedure while the UE is in the flying state.

An apparatus for wireless communications at a base station is described. The apparatus may include a processor, and a memory coupled with the processor, where the memory includes instructions executable by the processor to cause the apparatus to receive a message as part of an emergency communication procedure, the message associated with a UE, identify that the UE meets one or more flying state conditions indicative that the UE is in a flying state, and participate in the emergency communication procedure while the UE is in the flying state.

Another apparatus for wireless communications at a base station is described. The apparatus may include means for receiving a message as part of an emergency communication procedure, the message associated with a UE, means for identifying that the UE meets one or more flying state conditions indicative that the UE is in a flying state, and means for participating in the emergency communication procedure while the UE is in the flying state.

A non-transitory computer-readable medium storing code for wireless communications at a base station is described. The code may include instructions executable by a processor to receive a message as part of an emergency communication procedure, the message associated with a UE, identify that the UE meets one or more flying state conditions indicative that the UE is in a flying state, and participate in the emergency communication procedure while the UE is in the flying state.

In some examples of the method, apparatuses, and non-transitory computer-readable medium described herein, receiving the message may include operations, features, means, or instructions for receiving a session initiation protocol message in accordance with a user provided location information procedure, where the session initiation protocol message includes an indication that the UE meets the one or more flying state conditions.

In some examples of the method, apparatuses, and non-transitory computer-readable medium described herein, the session initiation protocol message may be an access network information header included in a session initiation protocol.

In some examples of the method, apparatuses, and non-transitory computer-readable medium described herein, receiving the message may include operations, features, means, or instructions for receiving an invite to participate in the emergency communication procedure, the invite including an indication that the UE meets the one or more flying state conditions.

In some examples of the method, apparatuses, and non-transitory computer-readable medium described herein, identifying that the UE meets the one or more flying state conditions may include operations, features, means, or instructions for identifying via a location retrieval function in accordance with a network provided location information procedure that the UE meets the one or more flying state conditions.

In some examples of the method, apparatuses, and non-transitory computer-readable medium described herein, identifying that the UE meets the one or more flying state conditions may include operations, features, means, or instructions for identifying via a policy and charging control procedure that the UE meets the one or more flying state conditions.

In some examples of the method, apparatuses, and non-transitory computer-readable medium described herein, receiving the message may include operations, features, means, or instructions for receiving a radio resource control session connection request message including an indication that the UE meets the one or more flying state conditions, where identifying that the UE meets the one or more flying state conditions may be based on the radio resource control session connection request message.

In some examples of the method, apparatuses, and non-transitory computer-readable medium described herein, receiving the message may include operations, features, means, or instructions for receiving a non-access stratum packet data network connection message including an indication that the UE meets the one or more flying state conditions, where identifying that the UE meets the one or more flying state conditions may be based on the non-access stratum packet data network connection message.

In some examples of the method, apparatuses, and non-transitory computer-readable medium described herein, receiving the message may include operations, features, means, or instructions for receiving a medium access control (MAC) control element (MAC-CE) message including an indication that the UE meets the one or more flying state conditions, where identifying that the UE meets the one or more flying state conditions may be based on the media access control (MAC)-CE message.

In some examples of the method, apparatuses, and non-transitory computer-readable medium described herein, receiving the message may include operations, features, means, or instructions for receiving a registration message including an indication that the UE meets the one or more flying state conditions, where identifying that the UE meets the one or more flying state conditions may be based on the registration message.

In some examples of the method, apparatuses, and non-transitory computer-readable medium described herein, receiving the message may include operations, features, means, or instructions for receiving a protocol data unit session establishment message including a request type, where the request type indicates an emergency request and that the UE meets the one or more flying state conditions, where identifying that the UE meets the one or more flying state conditions may be based on the protocol data unit session establishment message.

In some examples of the method, apparatuses, and non-transitory computer-readable medium described herein, receiving the message may include operations, features, means, or instructions for receiving the message via a frequency band dedicated to aerial vehicles, where identifying that the UE meets the one or more flying state conditions may be based on the frequency band.

In some examples of the method, apparatuses, and non-transitory computer-readable medium described herein, receiving the message may include operations, features, means, or instructions for receiving the message via an aerial vehicle on which the UE may be boarded for a flight, where participating in the emergency communication procedure may be based on receiving the message via the aerial vehicle.

Some examples of the method, apparatuses, and non-transitory computer-readable medium described herein may further include operations, features, means, or instructions for receiving an indication of a height of the UE, where identifying that the UE meets the one or more flying state conditions may be based on the height.

Some examples of the method, apparatuses, and non-transitory computer-readable medium described herein may further include operations, features, means, or instructions for receiving information associated with an aerial vehicle on which the UE may be boarded for a flight, where the information includes a broadcast remote identifier (BRID) of the aerial vehicle, a location of the aerial vehicle, a flight path, a flight number, a flight plan, or a combination thereof, where identifying that the UE meets the one or more flying state conditions may be based on the information.

In some examples of the method, apparatuses, and non-transitory computer-readable medium described herein, identifying that the UE meets the one or more flying state conditions may include operations, features, means, or instructions for identifying that the UE meets the one or more flying state conditions via UE based location reporting, network based location reporting, or a combination thereof.

Some examples of the method, apparatuses, and non-transitory computer-readable medium described herein may further include operations, features, means, or instructions for determining whether the base station supports emergency services for UEs in the flying state and transmitting an indication of whether the base station supports the emergency services for UEs in the flying state, where participating in the emergency communication procedure may be based on the support.

In some examples of the method, apparatuses, and non-transitory computer-readable medium described herein, the base station transmits the indication via a broadcasted radio resource control message.

Some examples of the method, apparatuses, and non-transitory computer-readable medium described herein may further include operations, features, means, or instructions for transmitting, in response to the message and prior to participating in the emergency communication procedure, a request to provide input associated with the flying state.

### BRIEF DESCRIPTION OF THE DRAWINGS

FIG. 1 illustrates an example of a wireless communications system that supports techniques for performing communications while in a flying state in accordance with aspects of the present disclosure.

FIG. 2 illustrates an example of a wireless communications procedure that supports techniques for performing communications while in a flying state in accordance with aspects of the present disclosure.

FIGS. 3 through 5 illustrate examples of process flows that support techniques for performing communications while in a flying state in accordance with aspects of the present disclosure.

FIGS. 6 and 7 show block diagrams of devices that support techniques for performing communications while in a flying state in accordance with aspects of the present disclosure.

FIG. 8 shows a block diagram of a communications manager that supports techniques for performing communications while in a flying state in accordance with aspects of the present disclosure.

FIG. 9 shows a diagram of a system including a device that supports techniques for performing communications while in a flying state in accordance with aspects of the present disclosure.

FIGS. 10 and 11 show block diagrams of devices that support techniques for performing communications while in a flying state in accordance with aspects of the present disclosure.

FIG. 12 shows a block diagram of a communications manager that supports techniques for performing communications while in a flying state in accordance with aspects of the present disclosure.

FIG. 13 shows a diagram of a system including a device that supports techniques for performing communications while in a flying state in accordance with aspects of the present disclosure.

FIGS. 14 through 17 show flowcharts illustrating methods that support techniques for performing communications while in a flying state in accordance with aspects of the present disclosure.

### DETAILED DESCRIPTION

In some wireless communications systems, a user equipment (UE) may be aboard (e.g., a passenger on) an aerial vehicle (e.g., an unmanned aerial vehicle (UAV), an un-crewed aerial vehicle, a low-altitude flying vehicle, etc.). In some cases, the UE may determine to perform an emergency call, or some other emergency communication and may transmit a request or otherwise initiate the emergency call with a base station. As the UE is aboard an aerial vehicle, the UE may be moving above ground (e.g., flying) when the UE determines to perform the emergency call. Base stations typically direct beams toward the ground, rather than towards the sky and therefore primary beams (e.g., lobes) of a base station may not be able to serve an aerial UE. However, back lobes and/or side lobes may propagate from the base station and may be directed upwards. Therefore, a UE aboard an aerial vehicle may initiate an emergency call with a base station based on the back lobes of the base station, regardless of whether this base station is among one of the closest base stations to the UE. In such cases, the base station may incorrectly determine that the initiating UE and/or the emergency call initiation message is invalid (e.g., fake) because the UE should have initiated the call with at least one base station among the closest base stations and accordingly may not participate in an emergency call procedure with the UE.

If, however, the base station proceeds to serve the emergency call and alerts emergency services (e.g., medical service, fire department services, rescue services) to aid the UE, the base station may alert undesirable emergency services because the base station may incorrectly determine and/or assume the location of the UE, or have no way of correctly determining the location of the UE. For example, an aerial UE may in fact be closest to a first base station but the UE may have initiated the emergency call with a second base station based on a configuration of the first base station versus the second base station with respect to the UE. For example, primary lobes of the first base station and the second base station may be directed to the ground (e.g., to serve UEs on the ground), the back lobes and/or side lobes of the first base station may not be directed toward the aerial UE, but the back lobes and/or side lobes of the second base station may be. In such cases, upon receiving an emergency call message from the UE, the second base station may incorrectly assume the UE is nearer to the second base station and alert emergency services nearby the second base station to aid the aerial UE. However, as emergency situations may be time sensitive, the second base station should have alerted emergency services near the first base station because the aerial UE was closer to the first base station and therefore, the emergency service near the first base station may be able to aid and/or reach the aerial UE faster than the emergency services near the second base station.

To improve emergency communications while abroad an aerial vehicle, a UE may be configured to report, to a base station, information to aid the base station in determining how to provide emergency services to the UE. For example, the UE may transmit an indication that the UE is flying, not on the ground, a passenger of aerial vehicle, etc. In some cases, the UE may report the flying indication during a radio resource control (RRC) connection establishment procedure, upon initiating an emergency call (e.g., in a SIP, via NPLI), via a medium access control (MAC) control element (MAC-CE) message, in a registration procedure, in a protocol data unit (PDU) session establishment procedure, etc. In some cases, the UE may additionally report a height of the UE, and/or additional information associated with the aerial vehicle (e.g., a vehicle ID, a flight plan). In some cases, the UE may use a frequency band dedicated to aerial vehicles for initiating the call, where the frequency band may indicate to the base station that the UE is an aerial UE.

The base station may therefore receive a message from the UE and determine whether it supports providing emergency services to aerial UEs (e.g., before or after receiving the message from the UE). If the base station supports emergency procedures for aerial UEs, the base station may participate in the emergency call with the UE and alert emergency services accordingly based on the flying state of the UE, the location of the UE, information associated with the aerial vehicle the UE is aboard, etc. If the base station does not support providing emergency services to aerial UEs but does support providing emergency services to aerial vehicles, the base station may indicate such to the UE and instead the UE may initiate the emergency call via the aerial vehicle (e.g., via transceivers of the aerial vehicle). In some implementations, prior to transmitting the message to the base station, the UE may determine whether the base station supports providing emergency services to the UE (specifically) and/or to aerial UEs (generally). The UE may determine such via an access and mobility management function (AMF), via a system broadcast, etc. If the UE determines that the base station supports providing emergency services, the UE may transmit the message (e.g., an emergency message) to the base station. If, however, the UE determines that the base station does not support providing emergency services, the UE may determine to refrain from initiating an emergency procedure with the base station and in some cases may fallback to the aerial vehicle to request emergency services.

Particular aspects of the subject matter described herein may be implemented to realize one or more advantages. The described techniques may support improvements in emergency call procedures performed by an aerial UE (e.g., a UE that is aboard an aerial vehicle, a passenger UE of an aerial vehicle, otherwise moving above ground) by improving reliability, and decreasing latency among other advantages. As such, supported techniques may include improved network operations and, in some examples, may promote network efficiencies, among other benefits.

Aspects of the disclosure are initially described in the context of wireless communications systems. Aspects are then described with reference to process flows. Aspects of the disclosure are further illustrated by and described with reference to apparatus diagrams, system diagrams, and flowcharts that relate to techniques for performing communications while in a flying state.

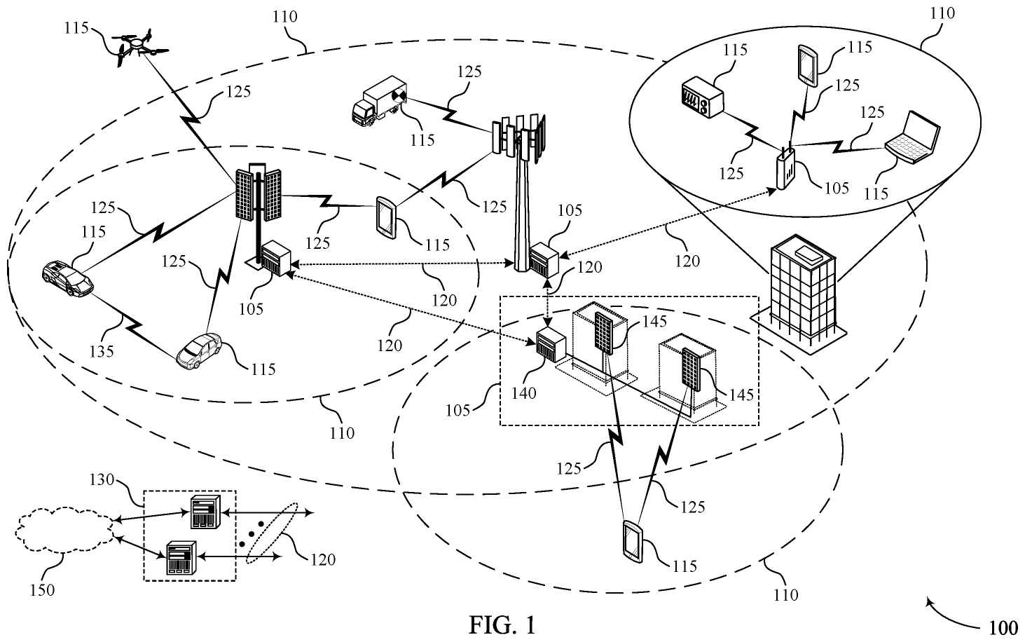

FIG. 1 illustrates an example of a wireless communications system 100 that supports techniques for performing communications while in a flying state in accordance with aspects of the present disclosure. The wireless communications system 100 may include one or more base stations 105, one or more UEs 115, and a core network 130. In some examples, the wireless communications system 100 may be a Long Term Evolution (LTE) network, an LTE-Advanced (LTE-A) network, an LTE-A Pro network, or a New Radio (NR) network. In some examples, the wireless communications system 100 may support enhanced broadband communications, ultra-reliable communications, low latency communications, communications with low-cost and low-complexity devices, or any combination thereof.

The base stations 105 may be dispersed throughout a geographic area to form the wireless communications system 100 and may be devices in different forms or having different capabilities. The base stations 105 and the UEs 115 may wirelessly communicate via one or more communication links 125. Each base station 105 may provide a coverage area 110 over which the UEs 115 and the base station 105 may establish one or more communication links 125. The coverage area 110 may be an example of a geographic area over which a base station 105 and a UE 115 may support the communication of signals according to one or more radio access technologies.

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be able to communicate with various types of devices, such as other UEs 115, the base stations 105, or network equipment (e.g., core network nodes, relay devices, integrated access and backhaul (IAB) nodes, or other network equipment), as shown in FIG. 1.

In some examples, one or more components of the wireless communications system 100 may operate as or be referred to as a network node. As used herein, a network node may refer to any UE 115, base station 105, entity of a core network 130, apparatus, device, or computing system configured to perform any techniques described herein. For example, a network node may be a UE 115. As another example, a network node may be a base station 105. As another example, a first network node may be configured to communicate with a second network node or a third network node. In one aspect of this example, the first network node may be a UE 115, the second network node may be a base station 105, and the third network node may be a UE 115. In another aspect of this example, the first network node may be a UE 115, the second network node may be a base station 105, and the third network node may be a base station 105. In yet other aspects of this example, the first, second, and third network nodes may be different. Similarly, reference to a UE 115, a base station 105, an apparatus, a device, or a computing system may include disclosure of the UE 115, base station 105, apparatus, device, or computing system being a network node. For example, disclosure that a UE 115 is configured to receive information from a base station 105 also discloses that a first network node is configured to receive information from a second network node. In this example, consistent with this disclosure, the first network node may refer to a first UE 115, a first base station 105, a first apparatus, a first device, or a first computing system configured to receive the information; and the second network node may refer to a second UE 115, a second base station 105, a second apparatus, a second device, or a second computing system.

The base stations 105 may communicate with the core network 130, or with one another, or both. For example, the base stations 105 may interface with the core network 130 through one or more backhaul links 120 (e.g., via an S1, N2, N3, or other interface). The base stations 105 may communicate with one another over the backhaul links 120 (e.g., via an X2, Xn, or other interface) either directly (e.g., directly between base stations 105), or indirectly (e.g., via core network 130), or both. In some examples, the backhaul links 120 may be or include one or more wireless links.

One or more of the base stations 105 described herein may include or may be referred to by a person having ordinary skill in the art as a base transceiver station, a radio base station, an access point, a radio transceiver, a NodeB, an eNodeB (eNB), a next-generation NodeB or a giga-NodeB (either of which may be referred to as a gNB), a Home NodeB, a Home eNodeB, or other suitable terminology.

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, or vehicles, meters, among other examples. In some cases, a UE 115 may refer to an aerial vehicle (e.g., a UAV), or a UE 115 aboard an aerial vehicle.

The UEs 115 described herein may be able to communicate with various types of devices, such as other UEs 115 that may sometimes act as relays as well as the base stations 105 and the network equipment including macro eNBs or gNBs, small cell eNBs or gNBs, or relay base stations, among other examples, as shown in FIG. 1.

The UEs 115 and the base stations 105 may wirelessly communicate with one another via one or more communication links 125 over one or more carriers. The term “carrier” may refer to a set of radio frequency spectrum resources having a defined physical layer structure for supporting the communication links 125. For example, a carrier used for a communication link 125 may include a portion of a radio frequency spectrum band (e.g., a bandwidth part (BWP)) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers.

Signal waveforms transmitted over a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may consist of one symbol period (e.g., a duration of one modulation symbol) and one subcarrier, where the symbol period and subcarrier spacing are inversely related. The number of bits carried by each resource element may depend on the modulation scheme (e.g., the order of the modulation scheme, the coding rate of the modulation scheme, or both). Thus, the more resource elements that a UE 115 receives and the higher the order of the modulation scheme, the higher the data rate may be for the UE 115. A wireless communications resource may refer to a combination of a radio frequency spectrum resource, a time resource, and a spatial resource (e.g., spatial layers or beams), and the use of multiple spatial layers may further increase the data rate or data integrity for communications with a UE 115.

The time intervals for the base stations 105 or the UEs 115 may be expressed in multiples of a basic time unit which may, for example, refer to a sampling period of Tₛ=1/(Δfₘₐₓ·N_{f}) seconds, where Δfₘₐₓ may represent the maximum supported subcarrier spacing, and N_{f} may represent the maximum supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively numbered subframes or slots, and each subframe or slot may have the same duration. In some examples, a frame may be divided (e.g., in the time domain) into subframes, and each subframe may be further divided into a number of slots. Alternatively, each frame may include a variable number of slots, and the number of slots may depend on subcarrier spacing. Each slot may include a number of symbol periods (e.g., depending on the length of the cyclic prefix prepended to each symbol period). In some wireless communications systems 100, a slot may further be divided into multiple mini-slots containing one or more symbols. Excluding the cyclic prefix, each symbol period may contain one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., the number of symbol periods in a TTI) may be variable. Additionally or alternatively, the smallest scheduling unit of the wireless communications system 100 may be dynamically selected (e.g., in bursts of shortened TTIs (sTTIs)).

Physical channels may be multiplexed on a carrier according to various techniques. A physical control channel and a physical data channel may be multiplexed on a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a number of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to a number of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

In some examples, a base station 105 may be movable and therefore provide communication coverage for a moving geographic coverage area 110. In some examples, different geographic coverage areas 110 associated with different technologies may overlap, but the different geographic coverage areas 110 may be supported by the same base station 105. In other examples, the overlapping geographic coverage areas 110 associated with different technologies may be supported by different base stations 105. The wireless communications system 100 may include, for example, a heterogeneous network in which different types of the base stations 105 provide coverage for various geographic coverage areas 110 using the same or different radio access technologies.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may also be able to communicate directly with other UEs 115 over a device-to-device (D2D) communication link 135 (e.g., using a peer-to-peer (P2P) or D2D protocol). One or more UEs 115 utilizing D2D communications may be within the geographic coverage area 110 of a base station 105. Other UEs 115 in such a group may be outside the geographic coverage area 110 of a base station 105 or be otherwise unable to receive transmissions from a base station 105. In some examples, groups of the UEs 115 communicating via D2D communications may utilize a one-to-many (1:M) system in which each UE 115 transmits to every other UE 115 in the group. In some examples, a base station 105 facilitates the scheduling of resources for D2D communications. In other cases, D2D communications are carried out between the UEs 115 without the involvement of a base station 105.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the base stations 105 associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

Some of the network devices, such as a base station 105, may include subcomponents such as an access network entity 140, which may be an example of an access node controller (ANC). Each access network entity 140 may communicate with the UEs 115 through one or more other access network transmission entities 145, which may be referred to as radio heads, smart radio heads, or transmission/reception points (TRPs). Each access network transmission entity 145 may include one or more antenna panels. In some configurations, various functions of each access network entity 140 or base station 105 may be distributed across various network devices (e.g., radio heads and ANCs) or consolidated into a single network device (e.g., a base station 105).

The wireless communications system 100 may operate using one or more frequency bands, typically in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. The UHF waves may be blocked or redirected by buildings and environmental features, but the waves may penetrate structures sufficiently for a macro cell to provide service to the UEs 115 located indoors. The transmission of UHF waves may be associated with smaller antennas and shorter ranges (e.g., less than 100 kilometers) compared to transmission using the smaller frequencies and longer waves of the high frequency (HF) or very high frequency (VHF) portion of the spectrum below 300 MHz.

The wireless communications system 100 may utilize both licensed and unlicensed radio frequency spectrum bands. For example, the wireless communications system 100 may employ License Assisted Access (LAA), LTE-Unlicensed (LTE-U) radio access technology, or NR technology in an unlicensed band such as the 5 GHz industrial, scientific, and medical (ISM) band. When operating in unlicensed radio frequency spectrum bands, devices such as the base stations 105 and the UEs 115 may employ carrier sensing for collision detection and avoidance. In some examples, operations in unlicensed bands may be based on a carrier aggregation configuration in conjunction with component carriers operating in a licensed band (e.g., LAA). Operations in unlicensed spectrum may include downlink transmissions, uplink transmissions, P2P transmissions, or D2D transmissions, among other examples.

A base station 105 or a UE 115 may be equipped with multiple antennas, which may be used to employ techniques such as transmit diversity, receive diversity, multiple-input multiple-output (MIMO) communications, or beamforming. The antennas of a base station 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a base station 105 may be located in diverse geographic locations. A base station 105 may have an antenna array with a number of rows and columns of antenna ports that the base station 105 may use to support beamforming of communications with a UE 115. Likewise, a UE 115 may have one or more antenna arrays that may support various MIMO or beamforming operations. Additionally or alternatively, an antenna panel may support radio frequency beamforming for a signal transmitted via an antenna port.

Beamforming, which may also be referred to as spatial filtering, directional transmission, or directional reception, is a signal processing technique that may be used at a transmitting device or a receiving device (e.g., a base station 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating at particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

A base station 105 or a UE 115 may use beam sweeping techniques as part of beam forming operations. For example, a base station 105 may use multiple antennas or antenna arrays (e.g., antenna panels) to conduct beamforming operations for directional communications with a UE 115. Some signals (e.g., synchronization signals, reference signals, beam selection signals, or other control signals) may be transmitted by a base station 105 multiple times in different directions. For example, the base station 105 may transmit a signal according to different beamforming weight sets associated with different directions of transmission. Transmissions in different beam directions may be used to identify (e.g., by a transmitting device, such as a base station 105, or by a receiving device, such as a UE 115) a beam direction for later transmission or reception by the base station 105.

Some signals, such as data signals associated with a particular receiving device, may be transmitted by a base station 105 in a single beam direction (e.g., a direction associated with the receiving device, such as a UE 115). In some examples, the beam direction associated with transmissions along a single beam direction may be determined based on a signal that was transmitted in one or more beam directions. For example, a UE 115 may receive one or more of the signals transmitted by the base station 105 in different directions and may report to the base station 105 an indication of the signal that the UE 115 received with a highest signal quality or an otherwise acceptable signal quality.

In some examples, transmissions by a device (e.g., by a base station 105 or a UE 115) may be performed using multiple beam directions, and the device may use a combination of digital precoding or radio frequency beamforming to generate a combined beam for transmission (e.g., from a base station 105 to a UE 115). The UE 115 may report feedback that indicates precoding weights for one or more beam directions, and the feedback may correspond to a configured number of beams across a system bandwidth or one or more sub-bands. The base station 105 may transmit a reference signal (e.g., a cell-specific reference signal (CRS), a channel state information reference signal (CSI-RS)), which may be precoded or unprecoded. The UE 115 may provide feedback for beam selection, which may be a precoding matrix indicator (PMI) or codebook-based feedback (e.g., a multi-panel type codebook, a linear combination type codebook, a port selection type codebook). Although these techniques are described with reference to signals transmitted in one or more directions by a base station 105, a UE 115 may employ similar techniques for transmitting signals multiple times in different directions (e.g., for identifying a beam direction for subsequent transmission or reception by the UE 115) or for transmitting a signal in a single direction (e.g., for transmitting data to a receiving device).

A receiving device (e.g., a UE 115) may try multiple receive configurations (e.g., directional listening) when receiving various signals from the base station 105, such as synchronization signals, reference signals, beam selection signals, or other control signals. For example, a receiving device may try multiple receive directions by receiving via different antenna subarrays, by processing received signals according to different antenna subarrays, by receiving according to different receive beamforming weight sets (e.g., different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some examples, a receiving device may use a single receive configuration to receive along a single beam direction (e.g., when receiving a data signal). The single receive configuration may be aligned in a beam direction determined based on listening according to different receive configuration directions (e.g., a beam direction determined to have a highest signal strength, highest signal-to-noise ratio (SNR), or otherwise acceptable signal quality based on listening according to multiple beam directions).

In some wireless communications systems, such as wireless communications system 100, to improve emergency communications while abroad an aerial vehicle, a UE 115 may be configured to report, to a base station 105, information to aid the base station 105 in determining how to provide emergency services to the UE 115. For example, the UE 115 may transmit an indication that the UE 115 is flying, not on the ground, a passenger of aerial vehicle, etc. In some cases, the UE 115 may report the flying indication during an RRC connection establishment procedure, upon initiating an emergency call (e.g., in a SIP, via NPLI), via a MAC-CE, in a registration procedure, in a PDU session establishment procedure, etc. In some cases, the UE 115 may additionally report a height of the UE 115, and/or additional information associated with the aerial vehicle (e.g., vehicle ID, flight plan). In some cases, the UE 115 may use a frequency band dedicated to aerial vehicles for initiating the call, where the frequency band may indicate to the base station 105 that the UE 115 is an aerial UE 115.

The base station 105 may therefore receive a message from the UE 115 and determine whether it supports providing emergency services to aerial UEs 115. If the base station 105 supports emergency procedures for aerial UEs 115, the base station 105 may participate in the emergency call with the UE 115 and alert emergency services accordingly based on the flying state of the UE 115, the location of the UE 115, information associated with the aerial vehicle the UE 115 is aboard, etc. If the base station 105 does not support providing emergency services to aerial UEs 115 but does support providing emergency service to aerial vehicles, the base station 105 may indicate such to the UE 115 and instead the UE 115 may initiate the emergency call via the aerial vehicle (e.g., via transceivers of the aerial vehicle).

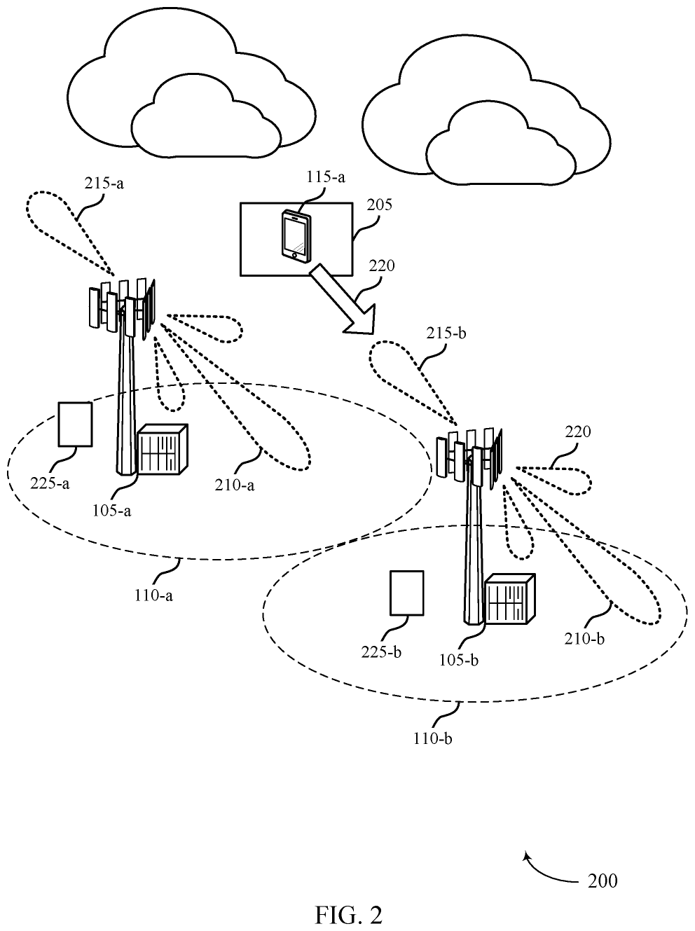

FIG. 2 illustrates an example of a wireless communications system 200 that supports techniques for performing communications while in a flying state in accordance with aspects of the present disclosure. The wireless communications system 200 may include base stations 105-a and 105-b, UE 115 a, and an aerial vehicle 205, which may be examples of the corresponding devices as described with reference to FIG. 1. Base station 105 a may serve a geographic coverage area 110-a, and base station 105-b may serve a geographic coverage area 110-b. In some cases, UE 115-a may be moving above ground (e.g., flying), such as because UE 115-a is boarded the aerial vehicle 205, and UE 115 a may determine to perform an emergency procedure with a network device (e.g., a base station 105). Additionally or alternatively, other wireless devices, such as a base station 105, an aerial vehicle, a network node, or some combination of the device described herein, may implement a same or similar emergency procedure.

In some wireless communications systems (e.g., wireless communications system 200), a UE 115 may be aboard (e.g., a passenger on) an aerial vehicle 205 (e.g., a UAV, an un-crewed aerial vehicle, a low-altitude flying vehicle, a helicopter, a plane, a vehicle within coverage of one or more terrestrial networks, any transportation vehicle that moves above ground). For example, UE 115-a may be aboard aerial vehicle 205. In some cases, the UE 115 may determine to perform an emergency call, or some other emergency communication (e.g., voice call, video call, text) and may transmit a request or otherwise initiate the emergency call with a base station 105. As UE 115-a is aboard the aerial vehicle 205, UE 115-a may be moving above ground (e.g., flying) when UE 115-a determines to perform the emergency call. Base stations 105 typically direct beams toward the ground, rather than towards the sky and therefore primary beams (e.g., a primary lobe 210) of a base station 105 may not be able to serve an aerial UE 115. For example, base station 105-a may produce at least primary lobe 210-a to communicate with UEs 115 on the ground and similarly base station 105-b may produce primary lobe 210-b. As primary lobes 210-a and 210-b are directed toward the ground, such lobes may not be used to serve UE 115-a that is above ground.

However, back lobes 215 (e.g., a lobe directly behind a primary lobe 210) and/or side lobes 220 (e.g., secondary lobes generated as a result of the primary lobe 210) may propagate from the base station and may be directed upwards. For example, back lobe 215-a, and one or more side lobes 220 may result when base station 105-a produces primary lobe 210-a. Similarly, back lobe 215-b, and one or more side lobes 220 may result when base station 105-b produces primary lobe 210-b. The one or more back lobes 215, side lobes 220, or a combination thereof may be directed upwards (e.g., toward UE 115-a) based on the direction, shape, strength, wavelength, etc., of the primary lobe 210.

Therefore, UE 115-a aboard aerial vehicle 205 may initiate an emergency call with a base station 105 based on the back lobes 215 and/or side lobes 220 of the base station 105, regardless of whether this base station 105 is the closest base station 105 to UE 115-a. For example, UE 115-a may determine to initiate an emergency call while aboard aerial vehicle 205 and UE 115-a may be physically closer to base station 105-a but may initiate the emergency call with base station 105-a based on the lobe configuration of base station 105-a and base station 105-b. Base station 105-a may not produce any lobes (e.g., primary lobes 210, back lobe 215, side lobes 220) that are directed toward UE 115-a, however, base station 105-b may. For example, back lobe 215-b may directed toward UE 115-a based on primary lobe 210-b.

In such cases, base station 105-b may incorrectly determine that the UE 115-a and/or the emergency call initiation message is invalid (e.g., fake) because UE 115-a should have initiated the call with at least one base station among the closest base station 105 (e.g., base station 105-a) and accordingly base station 105-b may determine to not participate in the emergency call procedure with UE 115-a. If however, base station 105-b proceeds to serve the emergency call and alerts emergency services 225 (e.g., medical service, fire department services, rescue services) to aid UE 115-a, base station 105-b may alert undesirable emergency services 225. For example, base station 105-b may be configured to alert the nearest (appropriate) emergency services to base station 105-b. In another example, base station 105-b may incorrectly determine and/or assume the location of UE 115-a, or have no way of correctly determining the location of UE 105-a. For example, base station 105-b may determine to alert emergency service 225-b to aid UE 115-a based on the emergency call. However, as emergency situations may be time sensitive, base station 105-b should have alerted emergency services 225-a near base station 105-a because UE 115-a was closest to base station 105-a and therefore, the emergency service 225-a near base station 105-a may be able to aid and/or reach UE 115-a faster than the emergency services 225-b near base station 105-b.

In some cases, a base station's ability to serve UE 115-a may be impacted by location reporting from UE 115-a. For example, upon initiating an emergency call, UE 115-a may be configured to report location information of UE 115-a to the base station 105. However, while the UE's GPS may be accurate, the location reporting may be impaired if the aerial vehicle 205 is served on the back lobes 215 of one or more base stations 105 based on the height of the aerial vehicle 205. For example, UE 115-a may be configured to report a location of UE 115-a based on the GPS of UE 115-a but may not be configured to provide a height of UE 115-a. For example, when UE 115-a initiates an emergency call, UE 115-a may provide the GPS data of UE 115-a, and the base station 105 may first attempt to verify the provided location. However, the UE's GPS may report one location and the network's Location Retrieval Function (LRF) may report a different location based on a back lobe 215 serving the aerial vehicle 205 and/or UE 115-a, or the location validation may fail. Consequently, the base station 105-a may incorrectly reject the location of the UE 115 as being invalid because it is outside the serving area.

Accordingly, the location information provided to the base station 105 may be misleading as the base station 105 may be unable to determine that UE 115-a is not on the ground at the specified location, but rather at some height above the ground at the specified location. Additionally or alternatively, the base station 105 may be unable to determine that UE 115-a is initiating the emergency call while aboard an aerial vehicle 205. Additionally or alternatively, the base station 105 may be unable to verify the location information provided by UE 115-a.

To improve emergency communications while abroad an aerial vehicle 205, or while otherwise moving above ground, UE 115-a may be configured to report, to a base station 105, information to aid the base station 105 in determining how to provide emergency services to UE 115-a while UE 115-a meets one or more conditions of a flying state. UE 115-a may first identify whether UE 115-a is in a flying state. In some cases, UE 115-a may use one or more sensors (e.g., accelerometers, cameras, motion sensors, an engine intake flow sensor, an altitude sensor, inertial measurements, measurements associated with propeller motor speed, a current sensor, a tilt sensor, etc.) to determine whether UE 115-a is in a flying state. In some cases, a passenger may use a UE 115 to scan a code (e.g., QR code, barcode) associated with the aerial vehicle 205 before, during, after boarding the aerial vehicle 205, or a combination thereof, where the code may indicate information associated with the aerial vehicle 205, and/or flight information. The passenger may scan the code once per flight, or multiple times throughout the flight. For example, the information may include a flight start time, a flight end time, a flight path, a cruising elevation of the flight, an identifier associated with the flight, an identifier associated with the aerial vehicle, etc. Accordingly, the passenger UE 115 may use such information to determine whether UE 115-a is currently in a flying mode, or predict whether and/or when UE 115-a may satisfy conditions of a flying mode.

In some cases, the aerial vehicle 205 may be configured to transmit a message (e.g., a broadcast message, a unicast message) to passenger UEs 115 that indicates the information associated with the aerial vehicle 205, and/or flight information. In some cases, the aerial vehicle 205 may indicate flight markers, such as take-off, flying, descending, landing, on the ground, parked, etc. The aerial vehicle 205 may transmit the message once per flight, periodically throughout the flight, or aperiodically (e.g., as conditions change, as needed). Accordingly, UE 115-a may receive and/or identify (via a code) information associated with the flight and/or aerial vehicle 205 and determine whether UE 115-a is in a flying state.

Upon identifying UE 115-a is in a flying state, upon determining to initiate an emergency call, or a combination thereof, UE 115-a may transmit the information to aid the base station 105 in determining how to provide emergency services to UE 115-a while UE 115-a meets one or more conditions of the flying state. For example, in some implementations, UE 115-a may transmit an indication that the UE is flying, not on the ground, a passenger of aerial vehicle, etc. In some cases, UE 115-a may report the indication once (e.g., upon initiating an emergency call, upon identifying that UE 115-a meets one or more conditions of a flying state, etc.).

Additionally or alternatively, in some cases, UE 115-a may be configured to report a height of UE 115-a. UE 115-a may report the height of UE 115-a along with, or separate from other location information of UE 115-a (e.g., a GPS location). In some cases, UE 115-a may report the height continuously, periodically, or aperiodically. UE 115-a may be configured to report the height if the height of UE 115-a exceeds a threshold (e.g., a preconfigured threshold). In some implementations, UE 115-a may be configured to report the height as UE 115-a falls below a threshold, after first exceeding the same or a different threshold. For example, UE 115-a may be configured to report a height of the if UE 115-a exceeds a threshold height and then report the height of UE 115-a if UE 115-a falls back below the threshold height. In some cases, UE 115-a may be configured with a set of threshold heights.

In some cases, UE 115-a may report additional information associated with the aerial vehicle 205. For example, UE 115-a may include a broadcast remote ID (BRID) of the aerial vehicle 205 in which UE 115-a is a passenger of. In some cases, base station 105 may receive the BRID and translate (via a translation function) the BRID to another ID (e.g., a 3GPP ID). In some cases, base station 105-a may perform the translation using a lookup table, for example, where the lookup table, translation function, etc., may be setup at the time of authorizing the aerial vehicles for operation, or otherwise preconfigured.

UE 115-a may identify the BRID of the aerial vehicle 205 based on close proximity to the aerial vehicle 205. For example, if UE 115-a is within a threshold proximity to the aerial vehicle 205, such within the aerial vehicle 205, UE 115-a may be able to receive the BRID from the aerial vehicle 205. In another example, a passenger (associated with UE 115-a) may scan a code (e.g., QR code, barcode) upon boarding, upon determining to make an emergency call, throughout a flight, etc., where the code may indicate the BRID to UE 115-a. In another example, the aerial vehicle 205 may provide local services that may include transmitting the BRID (e.g., broadcast, unicast), where the aerial vehicle 205 may transmit the BRID periodically, once per flight, or aperiodically. For example, the aerial vehicle 205 may provide sidelink relaying and may broadcast a relay discovery broadcast message, that includes the BRID.

In another example, UE 115-a may indicate the flight information to the base station 105, such as the flight number, or flight authorization number obtained from the UTM. In such cases, the base station 105 may relay the flight number and/or flight authorization number to emergency service providers, which the emergency service providers may use to identify (e.g., look up) information of the aerial vehicle 205, such as where the aerial vehicle is, or headed, a flight path, an estimated land time, etc.

In another example, UE 115-a may include information about the location of the aerial vehicle 205, such as in the case that UE 115-a or the base station 105 are unable to identify the location of UE 115-a. In some cases, local services provided by the aerial vehicle 205 may include a periodic location information broadcast within the aerial vehicle 205.

In some cases, UE 115-a may use a frequency band dedicated to aerial vehicles 205 (in general) or dedicated to a particular aerial vehicle 205, such as the aerial vehicle on which UE 115-a is boarded, for initiating the call. In some cases, UE 115-a may use the aerial vehicle 205 dedicated frequency band when UE 115-a is a passenger of the aerial vehicle 205. As such, the aerial vehicle dedicated frequency band may implicitly indicate to the base station 105 that UE 115-a is flying by initiating the call over the aerial vehicle dedicated band. For example, the base station 105 may receive a message from UE 115-a (e.g., an emergency call message) over the aerial vehicle dedicated band and determine that in order to use the dedicated band, UE 115-a is aboard the aerial vehicle 205. In some cases, the LRF may use additional aerial vehicle specific (e.g., drone-specific) steps to obtain, verify, and/or validate the location of UE 115-a.

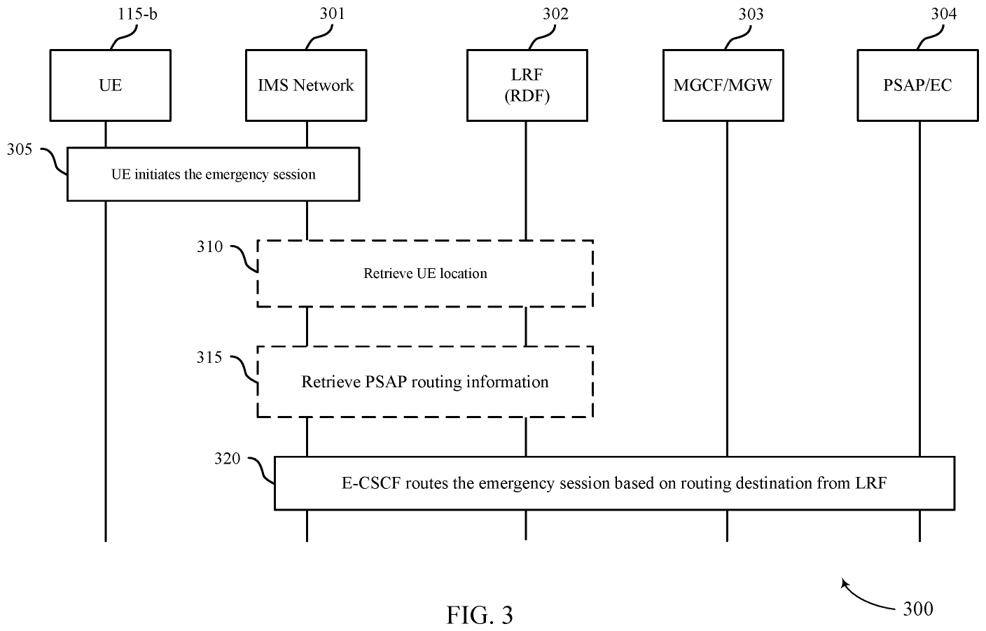

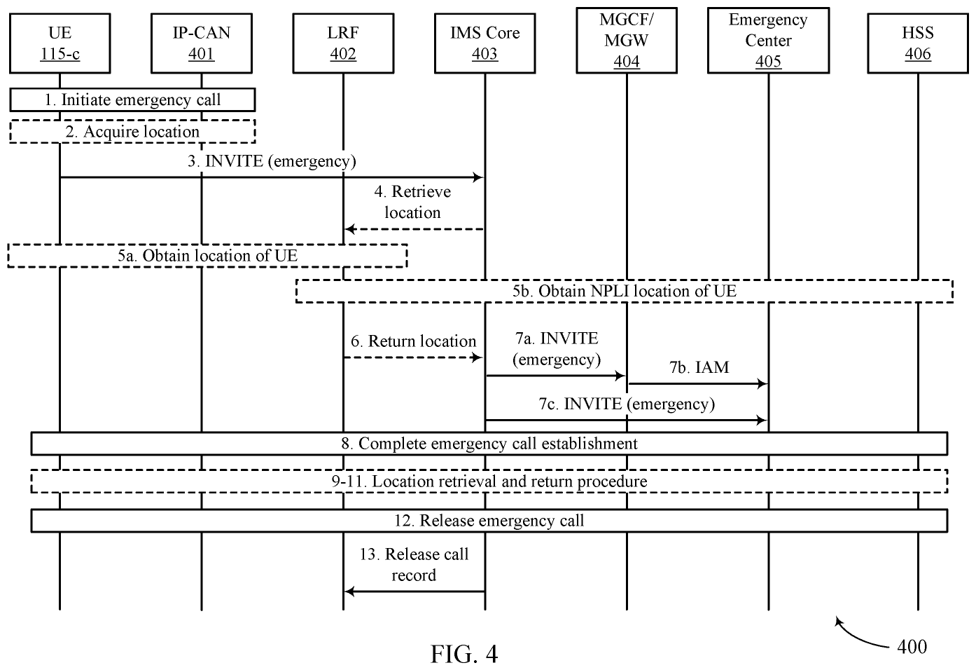

In some cases, and as described in more detail with reference to FIGS. 3 and 4, UE 115-a may report the flying indication, height information, aerial vehicle information, etc., during a radio resource control (RRC) connection establishment procedure, upon initiating an emergency call (e.g., in a SIP, via NPLI), via a medium access control (MAC) control element (MAC-CE) message, in a registration procedure, in a protocol data unit (PDU) session establishment procedure, etc.

Accordingly, UE 115-a may determine to initiate an emergency call, identify that UE 115-a is in a flying state, or vice versa and indicate information to base station 105 to indicate to the base station 105 that UE 115-a is in a flying state. In some cases, upon receiving such information from UE 115-a, the base station 105 may request additional information from UE 115-a, to confirm information, etc. For example, base station 105-a may request input from UE 115-a (e.g., the user of UE 115-a) before or after the emergency call is triggered. There may be user input before an emergency call is triggered and/or performed. For example, a user interface (UI) of UE 115-a may prompt the user to confirm whether the user is currently flying (e.g., “are you in an aerial vehicle now?”). Accordingly, the user may tap, click, touch, press, etc., “yes” to indicate the emergency call is being made from within a flying vehicle and/or while in a flying state.

In some cases, the base station 105 may receive a message from the UE 115 and determine whether it supports providing emergency services to aerial UEs 115 (in general) or to UE 115-a specifically. In some cases, a serving AMF may indicate to UE 115-a the indication of support for emergency services for aerial UEs 115 (e.g., whether base station 105 supports emergency services for aerial UE 115-a). The serving AMF may indicate such information within a registration accept message of a registration procedure, in an emergency services support message within the registration accept message, etc. The emergency services support for aerial UEs 115 may be set to positive if, in addition to and in addition to the configuration or local policies, the network (e.g., the base station 105) determines it can support emergency services for aerial UEs 115. Additionally, or alternatively, the indication may be included in an RRC message (e.g., broadcasted on the RRC level). For example, the support message may be included in an SIB, where the message may indicate whether the network (e.g., base station 105, the cell) supports emergency services for aerial UEs 115 or not.

If the base station 105 supports emergency procedures for aerial UEs 115, the base station 105 may participate in the emergency call with the UE 115 and alert emergency services accordingly based on the flying state of the UE 115, the location of the UE 115, information associated with the aerial vehicle the UE 115 is aboard, etc. In some cases, if UE 115-a detects it is in a flying mode and the received indication states no support for the emergency service, UE 115-a may not be able to attempt emergency services.

In some other cases, if the base station 105 does not support providing emergency services to aerial UEs 115 but does support providing emergency service to aerial vehicles, the base station 105 may indicate such to UE 115-a and instead UE 115-a may initiate the emergency call via the aerial vehicle 205 (e.g., via transceivers of the aerial vehicle 205). In some implementations, prior to transmitting an emergency message to the base station 105, the UE 115 may determine whether the base station 105 supports providing emergency services to the UE 115 (specifically) and/or to aerial UEs 115 (generally). The UE 115 may determine such via an AMF, via a system broadcast, etc. If the UE 115 determines that the base station 105 supports providing emergency services, the UE may transmit the message (e.g., an emergency message) to the base station, as described herein. If, however, the UE 115 determines that the base station 105 does not support providing emergency services, the UE 115 may determine to refrain from initiating an emergency procedure with the base station 105 and in some cases may fallback to the aerial vehicle 205 to request emergency services. For example, the base station 105 may support emergency services for aerial vehicles 205 but not directly for the aerial UEs 115 in a flying state (e.g., inside an aerial vehicle 205). In such cases, UE 115-a may transmit an emergency service request (e.g., an emergency call initiation) via the aerial vehicle 205 which may have better pathloss (e.g., due to no penetration loss compared to the aerial UEs 115 inside the aerial vehicle 205). The aerial vehicle 205 may accordingly relay the request for emergency services originating from one or more aerial UEs 115 to a base station 105. To reduce network access congestion, the aerial vehicle 205 may also be able to gather the requests from one or more passenger UEs 115 of the aerial vehicle 205 and/or report to a base station 105 how many such UEs 115 have or may have such requests.

In some cases, the aerial vehicle 205 may be configured to switch to the aerial vehicle dedicated band for the purpose of making the emergency call. For example, the aerial vehicle 205 may be operating in a band other than the aerial vehicle dedicated band (e.g., a commercial band) before making the emergency call. Upon receiving one or more requests from UEs 115 aboard the aerial vehicle to carry out an emergency call, the aerial vehicle may switch to the aerial vehicle dedicated band to perform the emergency call.

FIG. 3 illustrates an example of a process flow 300 that supports techniques for performing communications while in a flying state in accordance with aspects of the present disclosure. The process flow 300 may illustrate an example emergency call procedure for an aerial UE 115. For example, UE 115-b may be moving above ground (e.g., flying) and may determine to perform an emergency procedure with a network device (e.g., a base station), where the base station may be associated with one or more of an IMS network 301, and LRF (or RDF) 302, a MGCF (or MGW) 303, and an PSAP (or EC) 304. UE 115-b may be an example of the UEs 115 described with reference to FIG. 1. In some cases, instead of UE 115-b implementing the emergency call procedure, a different type of wireless device (e.g., a base station) may perform a same or similar procedure with an aerial device. Alternative examples of the following may be implemented, where some steps are performed in a different order than described or are not performed at all. In some cases, steps may include additional features not mentioned below, or further steps may be added.

At 305, UE 115-b (e.g., an aerial UE 115 aboard an aerial vehicle) may initiate an emergency session with a base station. For example, UE 115-b may initiate an emergency session with an IMS core 301. In accordance with techniques described herein, UE 115-b may include in an emergency cell initiation message, information associated with UE 115-b, the aerial vehicle, the flight, etc. For example, UE 115-b may include an indication that UE 115-b is in a flying state.

In some cases, at 310, the IMS core 301 may retrieve the location of UE 115-b via the LRF 302 (e.g., if required). In such cases, the IMS core 301 may relay or otherwise indicate the flying state indication to the LRF 302. In some cases, at 315, the IMS core and/or the LRF 302 may retrieve PSAP routing information associated with UE 115-b. At 320, the E-CSCF may route the emergency session based on routing destination from the LRF 302. Accordingly, UE 115-b may perform the emergency call while aboard an aerial vehicle based on providing the flying state indication to the IMS core 301 (e.g., a base station).

In some cases, if the UE 115 includes the flying state indication, the indication may be provided and/or forwarded to LRF 302. The network (e.g., base station) may use existing location reporting methods for locating the UE 115 accurately considering the flying state indication. For example, the network may use UE based location reporting, or network based location reporting in which the network may use P-CSCF triggers, areas of interest, etc. Additionally, or alternatively, the UE 115 may provide a cell ID (CGI), GPS coordinates, etc. The network may determine whether to identify additional location information from the UE 115, the network, or both. For example, a PSAP may request an initial location estimate and/or updated location estimate from the LRF.

FIG. 4 illustrates an example of a process flow 400 that supports techniques for performing communications while in a flying state in accordance with aspects of the present disclosure. The process flow 400 may illustrate an example emergency call procedure for an aerial UE 115. For example, UE 115-c may be moving above ground (e.g., flying) and may determine to perform an emergency procedure with a base station. The base station may be associated with one or more of an IP CAN 401, an LRF 402, an IMS core 403, an MGCF (or MGW) 404, an emergency center 405, an HSS 406. UE 115-c and devices 401 through 406 may be examples of the corresponding wireless devices described with reference to FIGS. 1 through 3. In some cases, instead of UE 115-c implementing the emergency call procedure, a different type of wireless device (e.g., a base station 105) may perform a same or similar procedure with an aerial device. Alternative examples of the following may be implemented, where some steps are performed in a different order than described or are not performed at all. In some cases, steps may include additional features not mentioned below, or further steps may be added.

UE 115-c (e.g., an aerial UE 115 aboard an aerial vehicle) may initiate an emergency session with a base station. In accordance with techniques described herein, UE 115-c may indicate information associated with UE 115-b, the aerial vehicle, the flight, etc. For example, UE 115-c may include an indication that UE 115-c is in a flying state. In some cases, and as described with reference to FIG. 2, UE 115-c may provide such an indication to a base station implicitly, or explicitly. For example, UE 115-a may provide (e.g., transmit) the indication to a P-CSCF in SIP signaling. For example, using UPLI, UE 115-c may provide the flying indication in a P-Access-Network-Info header in SIP signaling (e.g., an invite signal). The indication may be forwarded or otherwise provided to the P-CSCF, the PSAP, or a combination thereof.

For example, UE 115-c may initiate an emergency call with an IP-CAN 401, and acquire the location of UE 115-c via IP-CAN 401. UE 115-a may then transmit, to the IMS core 403 (e.g., a base station, a unit of a base station), an invite message that includes an emergency indication. The invite may include any location information that UE 115-c acquired. The location information may be geographical location information or a location identifier, which may be dependent upon the access network technology. In case UE 115-b is unable to provide any location information, the IMS core 403 may seek to determine the location of UE 115-c from the LRF 402. The invite may optionally contain information associated with location solutions and position methods supported by UE 115-c.

In another example, UE 115-c may provide the flying indication using NPLI. For example, using a PCC solution, the P-CSCF may query the PCF and/or the PCRF for the location of UE 115-c. In such cases, a cell identifier (e.g., base station identifier) may be provided. In some cases, the network may identify that UE 115-c uses the aerial vehicle dedicated band or is authorized as an aerial vehicle, and in such cases, UE 115-c may report the height (e.g., via RRC). Such an indication may impact procedures in P-CSCF/PCF and may result in extra information contained in ULI reporting from a RAN to a core network.

In another example, using the LRF 402, upon transmitting an emergency invite message (at step 3) and if the location information provided in step 3 is trusted and sufficient to determine the correct PSAP, the procedure continues from step 7 onwards. If the location information is insufficient or if the IMS core 403 requires emergency routing information, if the IMS core 403 is required to validate the location information, or if the IMS core 403 is required to map the location identifier received from UE 115-c into the corresponding geographical location information, the IMS core 403 may send a location request to the LRF. The request may include information identifying the IP-CAN and the UE 115 and may include means to access the UE 115 (e.g., the UE's IP address). The request may include any location information provided by the UE 115 in step 2. The request may optionally include any information associated with the location solutions and position methods supported by UE 115-c.

In some cases, at step 5 (e.g., a procedure to retrieve the UE's NPLI location), the LRF may have the information requested by the IMS core, or the LRF may request the UE's location information. The means to obtain the location information may differ depending on the access technology the UE 115 is using to access the IMS (e.g., Secure User Plane Location (SUPL) procedures, or via User Plane Location (UPL) Protocol, such as if UPL protocol is supported by the UE 115 and if it is possible to establish a user plane connection between the UE 115 and the SUPL server). Information provided in step 4 associated with the location solutions and position methods supported by the UE 115 may optionally be used by the LRF to help determine the means to obtain the location information. Thereon (e.g., any number or combination of steps 6 through 13), UE 115-a may perform the emergency call.

In some implementations, UE 115-c may provide the flying indication (and/or other information) in one or more RRC messages, such as an RRC establishment message transmitted by UE 115-c, in one or more MAC-CE message, UCI messages, in one or more NAS PDN connection messages, in one or more PDU session establishment messages, or a combination thereof. For example, the UE 115 may set the RRC establishment cause to emergency when it requests an RRC Connection in relation to an emergency session, and may also indicate that UE 115 is in a flying state.

In some cases, if UE 115 is in a limited-service state and triggers a registration procedure for emergency services and is in a flying state, the UE 115 may indicate such in the registration for emergency services. UEs 115 that had registered for normal services and do not have emergency PDU Sessions established and that are subject to Mobility Restriction in the present area or RAT (e.g., because of restricted tracking area) may initiate a UE Requested PDU Session Establishment procedure to receive Emergency Services (e.g., with a Request Type indicating “Emergency Request” and indicate that the UE is flying).

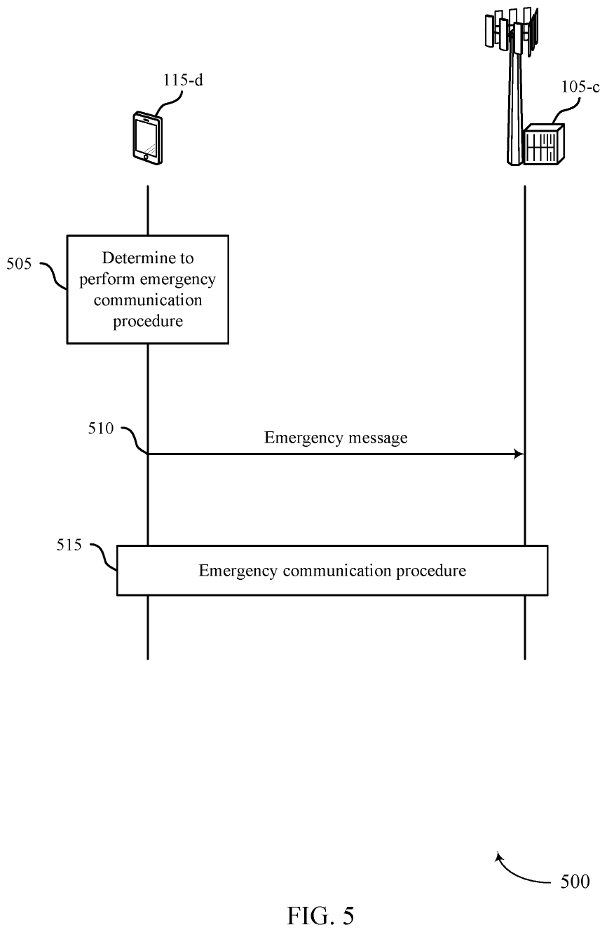

FIG. 5 illustrates an example of a process flow 500 that supports techniques for performing communications while in a flying state in accordance with aspects of the present disclosure. The process flow 500 may illustrate an example emergency call procedure for an aerial UE 115. For example, UE 115-d may be moving above ground (e.g., flying) and may determine to perform an emergency procedure with base station 105-c. Base station 105-c and UE 115-d may be examples of the corresponding wireless devices described with reference to FIGS. 1 through 4. In some cases, instead of UE 115-d implementing the emergency call procedure, a different type of wireless device (e.g., a base station 105) may perform a same or similar procedure with an aerial device. Alternative examples of the following may be implemented, where some steps are performed in a different order than described or are not performed at all. In some cases, steps may include additional features not mentioned below, or further steps may be added.

At 505, UE 115-d may determine to perform an emergency communication procedure while UE 115-d meets one or more flying state conditions indicative that UE 115-d is in a flying state. UE 115-d may determine that UE 115-d meets the one or more flying state conditions based on one or more sensors of UE 115-d (e.g., accelerometers, location sensors, motion sensors, cameras, GPS). In some cases, UE 115-d may determine that UE 115-d is abroad an aerial vehicle, and determine that UE 115-d meets the one or more flying state conditions based on identifying information associated with the aerial vehicle, where the information may include a flight path, a flight number, a flight plan, or a combination thereof. In implementations, UE 115-d may receive, from an aerial vehicle on which UE 115-d is boarded for a flight, a broadcast message including a flight metric, where the flight metric may indicate a benchmark of the flight, a flight identifier, flight plans, or a combination thereof. UE 115-d may determine that UE 115-d meets the one or more flying state conditions based on receiving the broadcast message.

At 510, UE 115-d may transmit a message to base station 105-c as part of the emergency communication procedure, where the message may be indicative that UE 115-d meets the one or more flying state conditions. Transmitting the message may include transmitting a session initiation protocol message in accordance with a user provided location information procedure, where the session initiation protocol message may include an indication that UE 115-d meets the one or more flying state conditions. The session initiation protocol message may be an access network information header included in a session initiation protocol.

In some cases, transmitting the message may include transmitting an invite to participate in the emergency communication procedure, where the invite may include an indication that UE 115-d meets the one or more flying state conditions. Transmitting the message may include transmitting the message to a location retrieval function in accordance with a network provided location information procedure. Transmitting the message may include transmitting a radio resource control session connection request message including an indication that UE 115-d meets the one or more flying state conditions based on determining to perform the emergency communication procedure. Transmitting the message may include transmitting a non-access stratum packet data network connection message including an indication that UE 115-d meets the one or more flying state conditions based on determining to perform the emergency communication procedure. Transmitting the message may include transmitting a MAC-CE message including an indication that UE 115-d meets the one or more flying state conditions based on determining to perform the emergency communication procedure.

In some implementations, transmitting the message may include determining that UE 115-d is in a limited-service state, and transmitting a registration message based on determining that UE 115-d is in the limited-service state. The registration message may include an indication that UE 115-d meets the one or more flying state conditions based on determining to perform the emergency communication procedure.

In some cases, transmitting the message may include determining that UE 115-d lacks an established emergency protocol data unit session, and transmitting a protocol data unit session establishment message including a request type, where the request type may indicate an emergency request and that UE 115-d meets the one or more flying state conditions.

In some cases, transmitting the message may include transmitting the message via a frequency band dedicated to aerial vehicles, such as a frequency band dedicated to at least eh aerial vehicle on which UE 115-d is a passenger. The frequency band may indicate, such as to base station 105-c, that UE 115-d meets the one or more flying state conditions because UE 115-d would not be able to use the aerial vehicle dedicated frequency band unless UE 115-d was flying. In some implementations, transmitting the message may include transmitting the message to base station 105-c via an aerial vehicle on which UE 115-d is boarded for a flight.

In some cases, UE 115-d may transmit an indication of a height of UE 115-d based on UE 115-d meeting the one or more flying state conditions of the flying state. UE 115-d may transmit information associated with an aerial vehicle on which UE 115-d is boarded for a flight. The information may include a broadcast remote identifier (BRID) of the aerial vehicle, a location of the aerial vehicle, a flight path, a flight number, a flight plan, or a combination thereof. UE 115-d may determine the information based on proximity to the aerial vehicle, a quick response code associated with the aerial vehicle, location services provided by the aerial vehicle, or a combination thereof. In some implementations, UE 115-d may receive, in response to the message and prior to participating in the emergency communication procedure, a request to provide input associated with the flying state.

In some cases, UE 115-d may receive an indication of whether emergency services for UEs 115 in the flying state are supported, where participating in the emergency communication procedure may be based on the support indicated. UE 115-d may receive the indication of support via an Access and Mobility Management Function or a system information block.

At 515, UE 115-d may participate in the emergency communication procedure while UE 115-d is in the flying state.

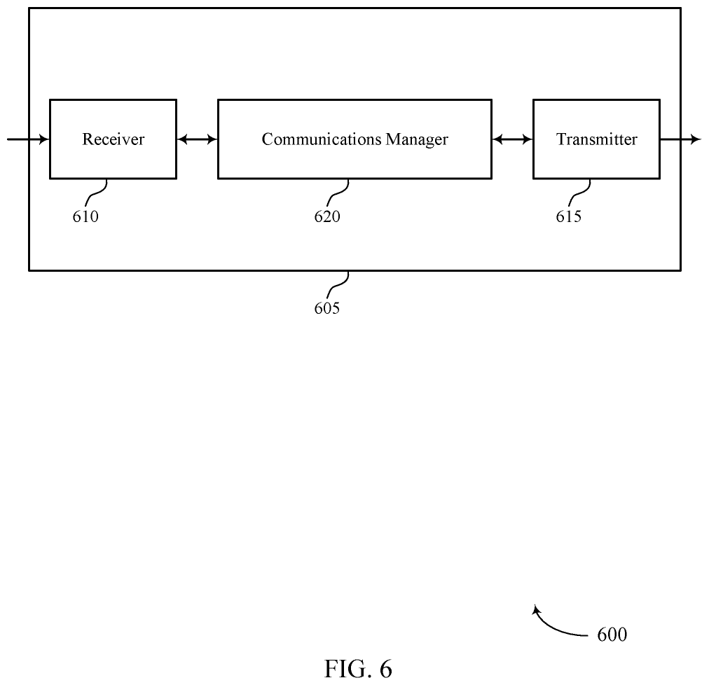

FIG. 6 shows a block diagram 600 of a device 605 that supports techniques for performing communications while in a flying state in accordance with aspects of the present disclosure. The device 605 may be an example of aspects of a UE 115 as described herein. The device 605 may include a receiver 610, a transmitter 615, and a communications manager 620. The device 605 may also include a processor. Each of these components may be in communication with one another (e.g., via one or more buses).

The receiver 610 may provide a means for receiving information such as packets, user data, control information, or any combination thereof associated with various information channels (e.g., control channels, data channels, information channels related to techniques for performing communications while in a flying state). Information may be passed on to other components of the device 605. The receiver 610 may utilize a single antenna or a set of multiple antennas.

The transmitter 615 may provide a means for transmitting signals generated by other components of the device 605. For example, the transmitter 615 may transmit information such as packets, user data, control information, or any combination thereof associated with various information channels (e.g., control channels, data channels, information channels related to techniques for performing communications while in a flying state). In some examples, the transmitter 615 may be co-located with a receiver 610 in a transceiver module. The transmitter 615 may utilize a single antenna or a set of multiple antennas.

The communications manager 620, the receiver 610, the transmitter 615, or various combinations thereof or various components thereof may be examples of means for performing various aspects of techniques for performing communications while in a flying state as described herein. For example, the communications manager 620, the receiver 610, the transmitter 615, or various combinations or components thereof may support a method for performing one or more of the functions described herein.

In some examples, the communications manager 620, the receiver 610, the transmitter 615, or various combinations or components thereof may be implemented in hardware (e.g., in communications management circuitry). The hardware may include a processor, a digital signal processor (DSP), an application-specific integrated circuit (ASIC), a field-programmable gate array (FPGA) or other programmable logic device, a discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally or alternatively, in some examples, the communications manager 620, the receiver 610, the transmitter 615, or various combinations or components thereof may be implemented in code (e.g., as communications management software or firmware) executed by a processor. If implemented in code executed by a processor, the functions of the communications manager 620, the receiver 610, the transmitter 615, or various combinations or components thereof may be performed by a general-purpose processor, a DSP, a central processing unit (CPU), an ASIC, an FPGA, or any combination of these or other programmable logic devices (e.g., configured as or otherwise supporting a means for performing the functions described in the present disclosure).

In some examples, the communications manager 620 may be configured to perform various operations (e.g., receiving, monitoring, transmitting) using or otherwise in cooperation with the receiver 610, the transmitter 615, or both. For example, the communications manager 620 may receive information from the receiver 610, send information to the transmitter 615, or be integrated in combination with the receiver 610, the transmitter 615, or both to receive information, transmit information, or perform various other operations as described herein.

The communications manager 620 may support wireless communications at a UE in accordance with examples as disclosed herein. For example, the communications manager 620 may be configured as or otherwise support a means for determining to perform an emergency communication procedure while the UE meets one or more flying state conditions indicative that the UE is in a flying state. The communications manager 620 may be configured as or otherwise support a means for transmitting a message to a base station as part of the emergency communication procedure, the message indicative that the UE meets the one or more flying state conditions. The communications manager 620 may be configured as or otherwise support a means for participating in the emergency communication procedure while the UE is in the flying state.

By including or configuring the communications manager 620 in accordance with examples as described herein, the device 605 (e.g., a processor controlling or otherwise coupled to the receiver 610, the transmitter 615, the communications manager 620, or a combination thereof) may support techniques for more efficient utilization of communication resources.

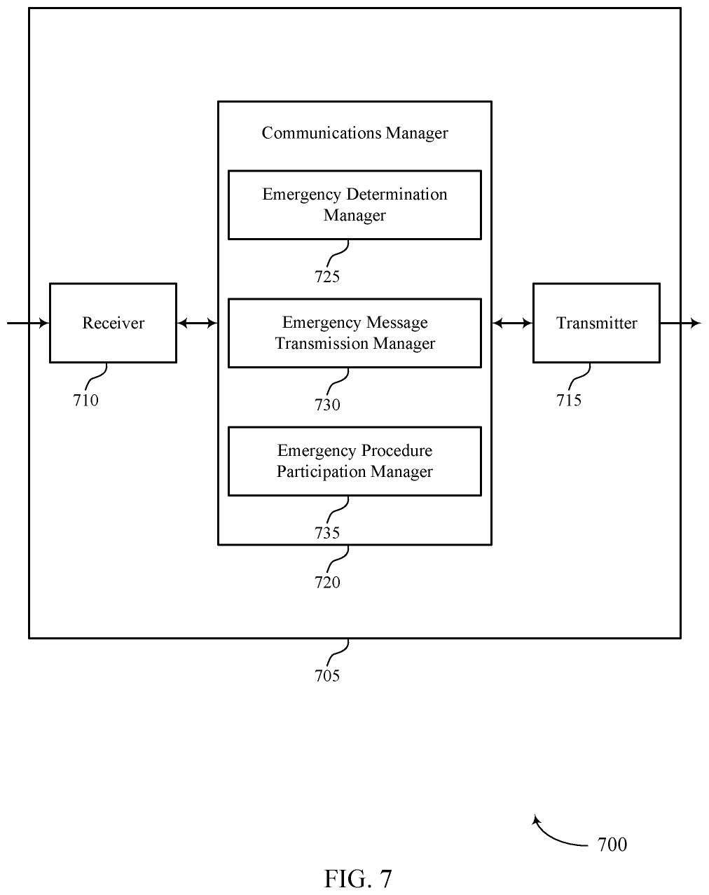

FIG. 7 shows a block diagram 700 of a device 705 that supports techniques for performing communications while in a flying state in accordance with aspects of the present disclosure. The device 705 may be an example of aspects of a device 605 or a UE 115 as described herein. The device 705 may include a receiver 710, a transmitter 715, and a communications manager 720. The device 705 may also include a processor. Each of these components may be in communication with one another (e.g., via one or more buses).

The receiver 710 may provide a means for receiving information such as packets, user data, control information, or any combination thereof associated with various information channels (e.g., control channels, data channels, information channels related to techniques for performing communications while in a flying state). Information may be passed on to other components of the device 705. The receiver 710 may utilize a single antenna or a set of multiple antennas.

The transmitter 715 may provide a means for transmitting signals generated by other components of the device 705. For example, the transmitter 715 may transmit information such as packets, user data, control information, or any combination thereof associated with various information channels (e.g., control channels, data channels, information channels related to techniques for performing communications while in a flying state). In some examples, the transmitter 715 may be co-located with a receiver 710 in a transceiver module. The transmitter 715 may utilize a single antenna or a set of multiple antennas.

The device 705, or various components thereof, may be an example of means for performing various aspects of techniques for performing communications while in a flying state as described herein. For example, the communications manager 720 may include an emergency determination manager 725, an emergency message transmission manager 730, an emergency procedure participation manager 735, or any combination thereof. The communications manager 720 may be an example of aspects of a communications manager 620 as described herein. In some examples, the communications manager 720, or various components thereof, may be configured to perform various operations (e.g., receiving, monitoring, transmitting) using or otherwise in cooperation with the receiver 710, the transmitter 715, or both. For example, the communications manager 720 may receive information from the receiver 710, send information to the transmitter 715, or be integrated in combination with the receiver 710, the transmitter 715, or both to receive information, transmit information, or perform various other operations as described herein.

The communications manager 720 may support wireless communications at a UE in accordance with examples as disclosed herein. The emergency determination manager 725 may be configured as or otherwise support a means for determining to perform an emergency communication procedure while the UE meets one or more flying state conditions indicative that the UE is in a flying state. The emergency message transmission manager 730 may be configured as or otherwise support a means for transmitting a message to a base station as part of the emergency communication procedure, the message indicative that the UE meets the one or more flying state conditions. The emergency procedure participation manager 735 may be configured as or otherwise support a means for participating in the emergency communication procedure while the UE is in the flying state.

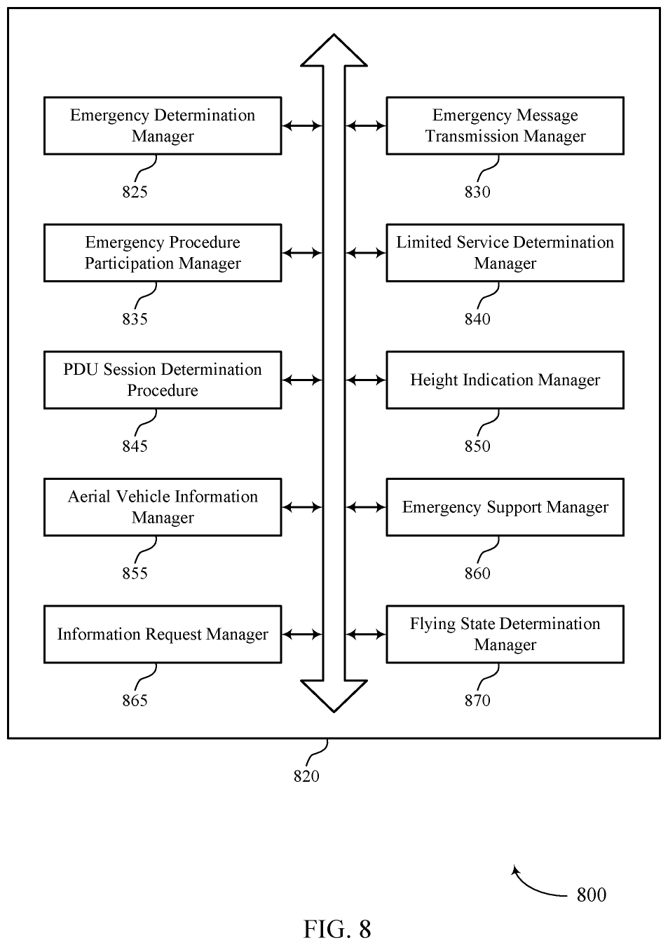

FIG. 8 shows a block diagram 800 of a communications manager 820 that supports techniques for performing communications while in a flying state in accordance with aspects of the present disclosure. The communications manager 820 may be an example of aspects of a communications manager 620, a communications manager 720, or both, as described herein. The communications manager 820, or various components thereof, may be an example of means for performing various aspects of techniques for performing communications while in a flying state as described herein. For example, the communications manager 820 may include an emergency determination manager 825, an emergency message transmission manager 830, an emergency procedure participation manager 835, a limited service determination manager 840, a PDU session determination procedure 845, a height indication manager 850, an aerial vehicle information manager 855, an emergency support manager 860, an information request manager 865, a flying state determination manager 870, or any combination thereof. Each of these components may communicate, directly or indirectly, with one another (e.g., via one or more buses).

The communications manager 820 may support wireless communications at a UE in accordance with examples as disclosed herein. The emergency determination manager 825 may be configured as or otherwise support a means for determining to perform an emergency communication procedure while the UE meets one or more flying state conditions indicative that the UE is in a flying state. The emergency message transmission manager 830 may be configured as or otherwise support a means for transmitting a message to a base station as part of the emergency communication procedure, the message indicative that the UE meets the one or more flying state conditions. The emergency procedure participation manager 835 may be configured as or otherwise support a means for participating in the emergency communication procedure while the UE is in the flying state.

In some examples, to support transmitting the message, the emergency message transmission manager 830 may be configured as or otherwise support a means for transmitting a session initiation protocol message in accordance with a user provided location information procedure, where the session initiation protocol message includes an indication that the UE meets the one or more flying state conditions.

In some examples, the session initiation protocol message is an access network information header included in a session initiation protocol.

In some examples, to support transmitting the message, the emergency message transmission manager 830 may be configured as or otherwise support a means for transmitting an invite to participate in the emergency communication procedure, the invite including an indication that the UE meets the one or more flying state conditions.

In some examples, to support transmitting the message, the emergency message transmission manager 830 may be configured as or otherwise support a means for transmitting the message to a location retrieval function in accordance with a network provided location information procedure.

In some examples, to support transmitting the message, the emergency message transmission manager 830 may be configured as or otherwise support a means for transmitting a radio resource control session connection request message including an indication that the UE meets the one or more flying state conditions based on determining to perform the emergency communication procedure.

In some examples, to support transmitting the message, the emergency message transmission manager 830 may be configured as or otherwise support a means for transmitting a non-access stratum packet data network connection message including an indication that the UE meets the one or more flying state conditions based on determining to perform the emergency communication procedure.

In some examples, to support transmitting the message, the emergency message transmission manager 830 may be configured as or otherwise support a means for transmitting a medium access control (MAC) control element (MAC-CE) message including an indication that the UE meets the one or more flying state conditions based on determining to perform the emergency communication procedure.

In some examples, to support transmitting the message, the limited service determination manager 840 may be configured as or otherwise support a means for determining that the UE is in a limited-service state. In some examples, to support transmitting the message, the emergency message transmission manager 830 may be configured as or otherwise support a means for transmitting a registration message based on determining that the UE is in the limited-service state, where the registration message includes an indication that the UE meets the one or more flying state conditions based on determining to perform the emergency communication procedure.

In some examples, to support transmitting the message, the PDU session determination procedure 845 may be configured as or otherwise support a means for determining that the UE lacks an established emergency protocol data unit session. In some examples, to support transmitting the message, the emergency message transmission manager 830 may be configured as or otherwise support a means for transmitting a protocol data unit session establishment message including a request type, where the request type indicates an emergency request and that the UE meets the one or more flying state conditions.

In some examples, to support transmitting the message, the emergency message transmission manager 830 may be configured as or otherwise support a means for transmitting the message via a frequency band dedicated to aerial vehicles, where the frequency band indicates that the UE meets the one or more flying state conditions.

In some examples, to support transmitting the message, the emergency message transmission manager 830 may be configured as or otherwise support a means for transmitting the message to the base station via an aerial vehicle on which the UE is boarded for a flight.

In some examples, the height indication manager 850 may be configured as or otherwise support a means for transmitting an indication of a height of the UE based on the UE meeting the one or more flying state conditions of the flying state.

In some examples, the aerial vehicle information manager 855 may be configured as or otherwise support a means for transmitting information associated with an aerial vehicle on which the UE is boarded for a flight.

In some examples, the information includes a broadcast remote identifier (BRID) of the aerial vehicle, a location of the aerial vehicle, a flight path, a flight number, a flight plan, or a combination thereof.

In some examples, the UE determines the information based on proximity to the aerial vehicle, a quick response code associated with the aerial vehicle, location services provided by the aerial vehicle, or a combination thereof.

In some examples, the emergency support manager 860 may be configured as or otherwise support a means for receiving an indication of whether emergency services for UEs in the flying state are supported, where participating in the emergency communication procedure is based on the support indicated.

In some examples, the UE receives the indication of support via an Access and Mobility Management Function or a system information block.

In some examples, the information request manager 865 may be configured as or otherwise support a means for receiving, in response to the message and prior to participating in the emergency communication procedure, a request to provide input associated with the flying state.

In some examples, the flying state determination manager 870 may be configured as or otherwise support a means for determining that the UE meets the one or more flying state conditions based on one or more sensors of the UE.

In some examples, the flying state determination manager 870 may be configured as or otherwise support a means for determining that the UE is abroad an aerial vehicle. In some examples, the flying state determination manager 870 may be configured as or otherwise support a means for determining that the UE meets the one or more flying state conditions based on identifying information associated with the aerial vehicle, where the information includes a flight path, a flight number, a flight plan, or a combination thereof.

In some examples, the flying state determination manager 870 may be configured as or otherwise support a means for receiving, from an aerial vehicle on which the UE is boarded for a flight, a broadcast message including a flight metric, where the flight metric indicates a benchmark of the flight, a flight identifier, flight plans, or a combination thereof. In some examples, the flying state determination manager 870 may be configured as or otherwise support a means for determining that the UE meets the one or more flying state conditions based on receiving the broadcast message.

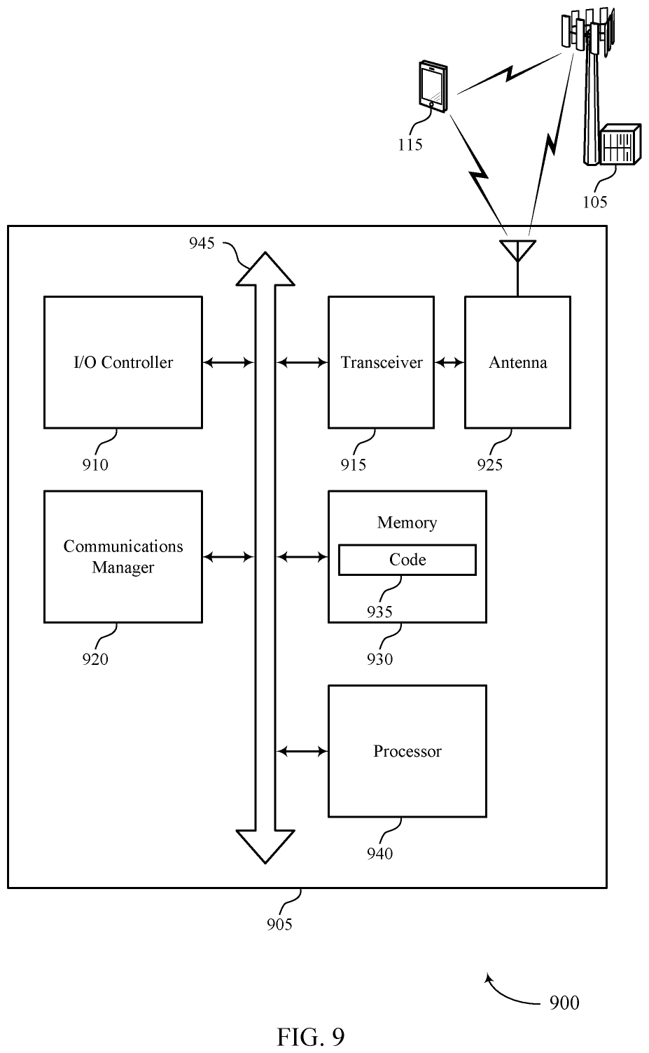

FIG. 9 shows a diagram of a system 900 including a device 905 that supports techniques for performing communications while in a flying state in accordance with aspects of the present disclosure. The device 905 may be an example of or include the components of a device 605, a device 705, or a UE 115 as described herein. The device 905 may communicate wirelessly with one or more base stations 105, UEs 115, or any combination thereof. The device 905 may include components for bi-directional voice and data communications including components for transmitting and receiving communications, such as a communications manager 920, an input/output (I/O) controller 910, a transceiver 915, an antenna 925, a memory 930, code 935, and a processor 940. These components may be in electronic communication or otherwise coupled (e.g., operatively, communicatively, functionally, electronically, electrically) via one or more buses (e.g., a bus 945).

The I/O controller 910 may manage input and output signals for the device 905. The I/O controller 910 may also manage peripherals not integrated into the device 905. In some cases, the I/O controller 910 may represent a physical connection or port to an external peripheral. In some cases, the I/O controller 910 may utilize an operating system such as iOS®, ANDROID®, MS-DOS®, MS-WINDOWS®, OS/2®, UNIX®, LINUX®, or another known operating system. Additionally or alternatively, the I/O controller 910 may represent or interact with a modem, a keyboard, a mouse, a touchscreen, or a similar device. In some cases, the I/O controller 910 may be implemented as part of a processor, such as the processor 940. In some cases, a user may interact with the device 905 via the I/O controller 910 or via hardware components controlled by the I/O controller 910.

In some cases, the device 905 may include a single antenna 925. However, in some other cases, the device 905 may have more than one antenna 925, which may be capable of concurrently transmitting or receiving multiple wireless transmissions. The transceiver 915 may communicate bi-directionally, via the one or more antennas 925, wired, or wireless links as described herein. For example, the transceiver 915 may represent a wireless transceiver and may communicate bi-directionally with another wireless transceiver. The transceiver 915 may also include a modem to modulate the packets, to provide the modulated packets to one or more antennas 925 for transmission, and to demodulate packets received from the one or more antennas 925. The transceiver 915, or the transceiver 915 and one or more antennas 925, may be an example of a transmitter 615, a transmitter 715, a receiver 610, a receiver 710, or any combination thereof or component thereof, as described herein.

The memory 930 may include random access memory (RAM) and read-only memory (ROM). The memory 930 may store computer-readable, computer-executable code 935 including instructions that, when executed by the processor 940, cause the device 905 to perform various functions described herein. The code 935 may be stored in a non-transitory computer-readable medium such as system memory or another type of memory. In some cases, the code 935 may not be directly executable by the processor 940 but may cause a computer (e.g., when compiled and executed) to perform functions described herein. In some cases, the memory 930 may contain, among other things, a basic I/O system (BIOS) which may control basic hardware or software operation such as the interaction with peripheral components or devices.

The processor 940 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 940 may be configured to operate a memory array using a memory controller. In some other cases, a memory controller may be integrated into the processor 940. The processor 940 may be configured to execute computer-readable instructions stored in a memory (e.g., the memory 930) to cause the device 905 to perform various functions (e.g., functions or tasks supporting techniques for performing communications while in a flying state). For example, the device 905 or a component of the device 905 may include a processor 940 and memory 930 coupled with or to the processor 940, the processor 940 and memory 930 configured to perform various functions described herein.

The communications manager 920 may support wireless communications at a UE in accordance with examples as disclosed herein. For example, the communications manager 920 may be configured as or otherwise support a means for determining to perform an emergency communication procedure while the UE meets one or more flying state conditions indicative that the UE is in a flying state. The communications manager 920 may be configured as or otherwise support a means for transmitting a message to a base station as part of the emergency communication procedure, the message indicative that the UE meets the one or more flying state conditions. The communications manager 920 may be configured as or otherwise support a means for participating in the emergency communication procedure while the UE is in the flying state.

By including or configuring the communications manager 920 in accordance with examples as described herein, the device 905 may support techniques for improved communication reliability, reduced latency, more efficient utilization of communication resources, and improved coordination between devices.

In some examples, the communications manager 920 may be configured to perform various operations (e.g., receiving, monitoring, transmitting) using or otherwise in cooperation with the transceiver 915, the one or more antennas 925, or any combination thereof. Although the communications manager 920 is illustrated as a separate component, in some examples, one or more functions described with reference to the communications manager 920 may be supported by or performed by the processor 940, the memory 930, the code 935, or any combination thereof. For example, the code 935 may include instructions executable by the processor 940 to cause the device 905 to perform various aspects of techniques for performing communications while in a flying state as described herein, or the processor 940 and the memory 930 may be otherwise configured to perform or support such operations.

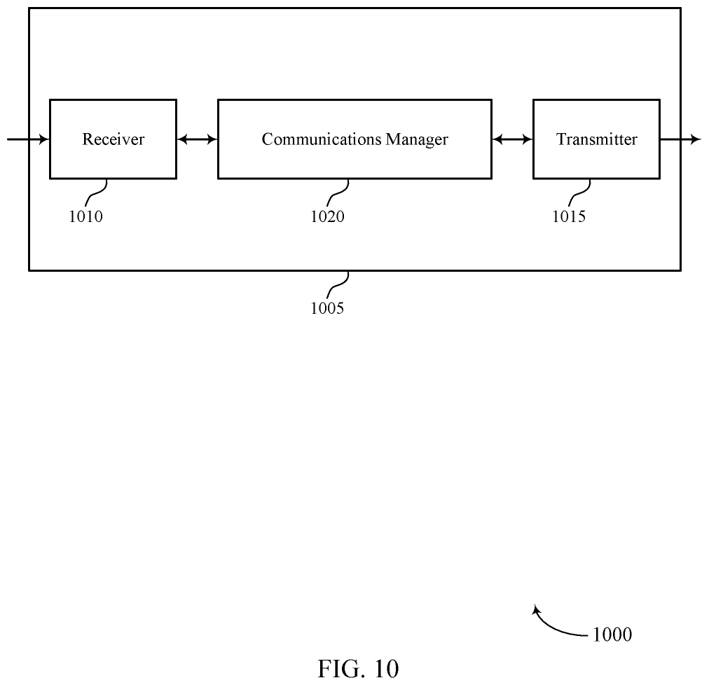

FIG. 10 shows a block diagram 1000 of a device 1005 that supports techniques for performing communications while in a flying state in accordance with aspects of the present disclosure. The device 1005 may be an example of aspects of a base station 105 as described herein. The device 1005 may include a receiver 1010, a transmitter 1015, and a communications manager 1020. The device 1005 may also include a processor. Each of these components may be in communication with one another (e.g., via one or more buses).

The receiver 1010 may provide a means for receiving information such as packets, user data, control information, or any combination thereof associated with various information channels (e.g., control channels, data channels, information channels related to techniques for performing communications while in a flying state). Information may be passed on to other components of the device 1005. The receiver 1010 may utilize a single antenna or a set of multiple antennas.

The transmitter 1015 may provide a means for transmitting signals generated by other components of the device 1005. For example, the transmitter 1015 may transmit information such as packets, user data, control information, or any combination thereof associated with various information channels (e.g., control channels, data channels, information channels related to techniques for performing communications while in a flying state). In some examples, the transmitter 1015 may be co-located with a receiver 1010 in a transceiver module. The transmitter 1015 may utilize a single antenna or a set of multiple antennas.

The communications manager 1020, the receiver 1010, the transmitter 1015, or various combinations thereof or various components thereof may be examples of means for performing various aspects of techniques for performing communications while in a flying state as described herein. For example, the communications manager 1020, the receiver 1010, the transmitter 1015, or various combinations or components thereof may support a method for performing one or more of the functions described herein.

In some examples, the communications manager 1020, the receiver 1010, the transmitter 1015, or various combinations or components thereof may be implemented in hardware (e.g., in communications management circuitry). The hardware may include a processor, a DSP, an ASIC, an FPGA or other programmable logic device, a discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally or alternatively, in some examples, the communications manager 1020, the receiver 1010, the transmitter 1015, or various combinations or components thereof may be implemented in code (e.g., as communications management software or firmware) executed by a processor. If implemented in code executed by a processor, the functions of the communications manager 1020, the receiver 1010, the transmitter 1015, or various combinations or components thereof may be performed by a general-purpose processor, a DSP, a CPU, an ASIC, an FPGA, or any combination of these or other programmable logic devices (e.g., configured as or otherwise supporting a means for performing the functions described in the present disclosure).

In some examples, the communications manager 1020 may be configured to perform various operations (e.g., receiving, monitoring, transmitting) using or otherwise in cooperation with the receiver 1010, the transmitter 1015, or both. For example, the communications manager 1020 may receive information from the receiver 1010, send information to the transmitter 1015, or be integrated in combination with the receiver 1010, the transmitter 1015, or both to receive information, transmit information, or perform various other operations as described herein.

The communications manager 1020 may support wireless communications at a base station in accordance with examples as disclosed herein. For example, the communications manager 1020 may be configured as or otherwise support a means for receiving a message as part of an emergency communication procedure, the message associated with a UE. The communications manager 1020 may be configured as or otherwise support a means for identifying that the UE meets one or more flying state conditions indicative that the UE is in a flying state. The communications manager 1020 may be configured as or otherwise support a means for participating in the emergency communication procedure while the UE is in the flying state.

By including or configuring the communications manager 1020 in accordance with examples as described herein, the device 1005 (e.g., a processor controlling or otherwise coupled to the receiver 1010, the transmitter 1015, the communications manager 1020, or a combination thereof) may support techniques for more efficient utilization of communication resources.

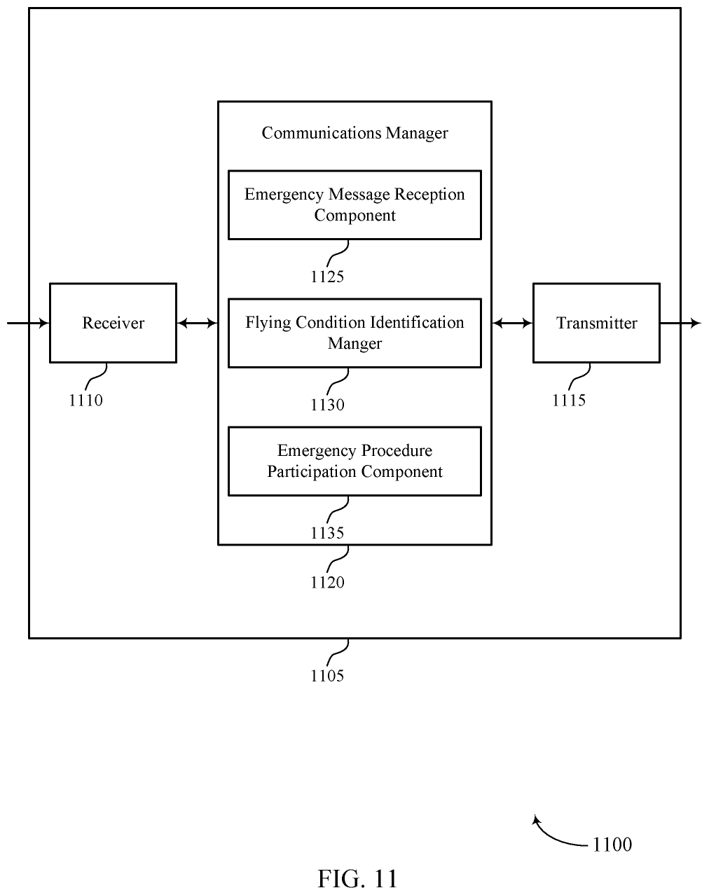

FIG. 11 shows a block diagram 1100 of a device 1105 that supports techniques for performing communications while in a flying state in accordance with aspects of the present disclosure. The device 1105 may be an example of aspects of a device 1005 or a base station 105 as described herein. The device 1105 may include a receiver 1110, a transmitter 1115, and a communications manager 1120. The device 1105 may also include a processor. Each of these components may be in communication with one another (e.g., via one or more buses).

The receiver 1110 may provide a means for receiving information such as packets, user data, control information, or any combination thereof associated with various information channels (e.g., control channels, data channels, information channels related to techniques for performing communications while in a flying state). Information may be passed on to other components of the device 1105. The receiver 1110 may utilize a single antenna or a set of multiple antennas.

The transmitter 1115 may provide a means for transmitting signals generated by other components of the device 1105. For example, the transmitter 1115 may transmit information such as packets, user data, control information, or any combination thereof associated with various information channels (e.g., control channels, data channels, information channels related to techniques for performing communications while in a flying state). In some examples, the transmitter 1115 may be co-located with a receiver 1110 in a transceiver module. The transmitter 1115 may utilize a single antenna or a set of multiple antennas.

The device 1105, or various components thereof, may be an example of means for performing various aspects of techniques for performing communications while in a flying state as described herein. For example, the communications manager 1120 may include an emergency message reception component 1125, a flying condition identification manger 1130, an emergency procedure participation component 1135, or any combination thereof. The communications manager 1120 may be an example of aspects of a communications manager 1020 as described herein. In some examples, the communications manager 1120, or various components thereof, may be configured to perform various operations (e.g., receiving, monitoring, transmitting) using or otherwise in cooperation with the receiver 1110, the transmitter 1115, or both. For example, the communications manager 1120 may receive information from the receiver 1110, send information to the transmitter 1115, or be integrated in combination with the receiver 1110, the transmitter 1115, or both to receive information, transmit information, or perform various other operations as described herein.

The communications manager 1120 may support wireless communications at a base station in accordance with examples as disclosed herein. The emergency message reception component 1125 may be configured as or otherwise support a means for receiving a message as part of an emergency communication procedure, the message associated with a UE. The flying condition identification manger 1130 may be configured as or otherwise support a means for identifying that the UE meets one or more flying state conditions indicative that the UE is in a flying state. The emergency procedure participation component 1135 may be configured as or otherwise support a means for participating in the emergency communication procedure while the UE is in the flying state.

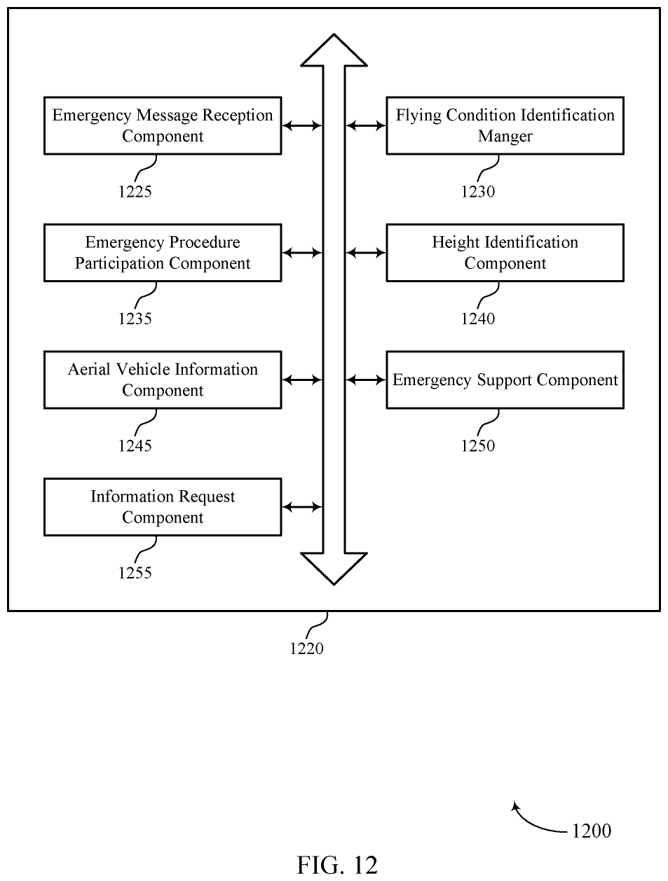

FIG. 12 shows a block diagram 1200 of a communications manager 1220 that supports techniques for performing communications while in a flying state in accordance with aspects of the present disclosure. The communications manager 1220 may be an example of aspects of a communications manager 1020, a communications manager 1120, or both, as described herein. The communications manager 1220, or various components thereof, may be an example of means for performing various aspects of techniques for performing communications while in a flying state as described herein. For example, the communications manager 1220 may include an emergency message reception component 1225, a flying condition identification manger 1230, an emergency procedure participation component 1235, a height identification component 1240, an aerial vehicle information component 1245, an emergency support component 1250, an information request component 1255, or any combination thereof. Each of these components may communicate, directly or indirectly, with one another (e.g., via one or more buses).

The communications manager 1220 may support wireless communications at a base station in accordance with examples as disclosed herein. The emergency message reception component 1225 may be configured as or otherwise support a means for receiving a message as part of an emergency communication procedure, the message associated with a UE. The flying condition identification manger 1230 may be configured as or otherwise support a means for identifying that the UE meets one or more flying state conditions indicative that the UE is in a flying state. The emergency procedure participation component 1235 may be configured as or otherwise support a means for participating in the emergency communication procedure while the UE is in the flying state.

In some examples, to support receiving the message, the emergency message reception component 1225 may be configured as or otherwise support a means for receiving a session initiation protocol message in accordance with a user provided location information procedure, where the session initiation protocol message includes an indication that the UE meets the one or more flying state conditions.

In some examples, the session initiation protocol message is an access network information header included in a session initiation protocol.

In some examples, to support receiving the message, the emergency message reception component 1225 may be configured as or otherwise support a means for receiving an invite to participate in the emergency communication procedure, the invite including an indication that the UE meets the one or more flying state conditions.

In some examples, to support identifying that the UE meets the one or more flying state conditions, the flying condition identification manger 1230 may be configured as or otherwise support a means for identifying via a location retrieval function in accordance with a network provided location information procedure that the UE meets the one or more flying state conditions.

In some examples, to support identifying that the UE meets the one or more flying state conditions, the flying condition identification manger 1230 may be configured as or otherwise support a means for identifying via a policy and charging control procedure that the UE meets the one or more flying state conditions.

In some examples, to support receiving the message, the emergency message reception component 1225 may be configured as or otherwise support a means for receiving a radio resource control session connection request message including an indication that the UE meets the one or more flying state conditions, where identifying that the UE meets the one or more flying state conditions is based on the radio resource control session connection request message.

In some examples, to support receiving the message, the emergency message reception component 1225 may be configured as or otherwise support a means for receiving a non-access stratum packet data network connection message including an indication that the UE meets the one or more flying state conditions, where identifying that the UE meets the one or more flying state conditions is based on the non-access stratum packet data network connection message.

In some examples, to support receiving the message, the emergency message reception component 1225 may be configured as or otherwise support a means for receiving a MAC-CE message including an indication that the UE meets the one or more flying state conditions, where identifying that the UE meets the one or more flying state conditions is based on the MAC-CE message.

In some examples, to support receiving the message, the emergency message reception component 1225 may be configured as or otherwise support a means for receiving a registration message including an indication that the UE meets the one or more flying state conditions, where identifying that the UE meets the one or more flying state conditions is based on the registration message.

In some examples, to support receiving the message, the emergency message reception component 1225 may be configured as or otherwise support a means for receiving a protocol data unit session establishment message including a request type, where the request type indicates an emergency request and that the UE meets the one or more flying state conditions, where identifying that the UE meets the one or more flying state conditions is based on the protocol data unit session establishment message.

In some examples, to support receiving the message, the emergency message reception component 1225 may be configured as or otherwise support a means for receiving the message via a frequency band dedicated to aerial vehicles, where identifying that the UE meets the one or more flying state conditions is based on the frequency band.

In some examples, to support receiving the message, the emergency message reception component 1225 may be configured as or otherwise support a means for receiving the message via an aerial vehicle on which the UE is boarded for a flight, where participating in the emergency communication procedure is based on receiving the message via the aerial vehicle.

In some examples, the height identification component 1240 may be configured as or otherwise support a means for receiving an indication of a height of the UE, where identifying that the UE meets the one or more flying state conditions is based on the height.

In some examples, the aerial vehicle information component 1245 may be configured as or otherwise support a means for receiving information associated with an aerial vehicle on which the UE is boarded for a flight, where the information includes a broadcast remote identifier (BRID) of the aerial vehicle, a location of the aerial vehicle, a flight path, a flight number, a flight plan, or a combination thereof, where identifying that the UE meets the one or more flying state conditions is based on the information.

In some examples, to support identifying that the UE meets the one or more flying state conditions, the flying condition identification manger 1230 may be configured as or otherwise support a means for identifying that the UE meets the one or more flying state conditions via UE based location reporting, network based location reporting, or a combination thereof.

In some examples, the emergency support component 1250 may be configured as or otherwise support a means for determining whether the base station supports emergency services for UEs in the flying state. In some examples, the emergency support component 1250 may be configured as or otherwise support a means for transmitting an indication of whether the base station supports the emergency services for UEs in the flying state, where participating in the emergency communication procedure is based on the support.

In some examples, the base station transmits the indication via a broadcasted radio resource control message.

In some examples, the information request component 1255 may be configured as or otherwise support a means for transmitting, in response to the message and prior to participating in the emergency communication procedure, a request to provide input associated with the flying state.

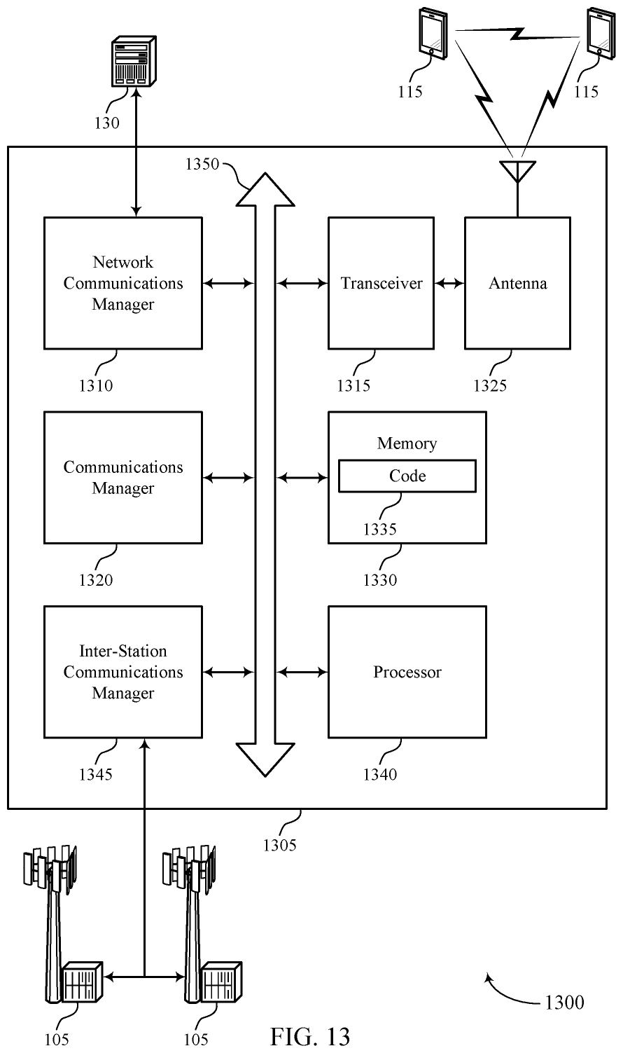

FIG. 13 shows a diagram of a system 1300 including a device 1305 that supports techniques for performing communications while in a flying state in accordance with aspects of the present disclosure. The device 1305 may be an example of or include the components of a device 1005, a device 1105, or a base station 105 as described herein. The device 1305 may communicate wirelessly with one or more base stations 105, UEs 115, or any combination thereof. The device 1305 may include components for bi-directional voice and data communications including components for transmitting and receiving communications, such as a communications manager 1320, a network communications manager 1310, a transceiver 1315, an antenna 1325, a memory 1330, code 1335, a processor 1340, and an inter-station communications manager 1345. These components may be in electronic communication or otherwise coupled (e.g., operatively, communicatively, functionally, electronically, electrically) via one or more buses (e.g., a bus 1350).

The network communications manager 1310 may manage communications with a core network 130 (e.g., via one or more wired backhaul links). For example, the network communications manager 1310 may manage the transfer of data communications for client devices, such as one or more UEs 115.

In some cases, the device 1305 may include a single antenna 1325. However, in some other cases the device 1305 may have more than one antenna 1325, which may be capable of concurrently transmitting or receiving multiple wireless transmissions. The transceiver 1315 may communicate bi-directionally, via the one or more antennas 1325, wired, or wireless links as described herein. For example, the transceiver 1315 may represent a wireless transceiver and may communicate bi-directionally with another wireless transceiver. The transceiver 1315 may also include a modem to modulate the packets, to provide the modulated packets to one or more antennas 1325 for transmission, and to demodulate packets received from the one or more antennas 1325. The transceiver 1315, or the transceiver 1315 and one or more antennas 1325, may be an example of a transmitter 1015, a transmitter 1115, a receiver 1010, a receiver 1110, or any combination thereof or component thereof, as described herein.

The memory 1330 may include RAM and ROM. The memory 1330 may store computer-readable, computer-executable code 1335 including instructions that, when executed by the processor 1340, cause the device 1305 to perform various functions described herein. The code 1335 may be stored in a non-transitory computer-readable medium such as system memory or another type of memory. In some cases, the code 1335 may not be directly executable by the processor 1340 but may cause a computer (e.g., when compiled and executed) to perform functions described herein. In some cases, the memory 1330 may contain, among other things, a BIOS which may control basic hardware or software operation such as the interaction with peripheral components or devices.

The processor 1340 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 1340 may be configured to operate a memory array using a memory controller. In some other cases, a memory controller may be integrated into the processor 1340. The processor 1340 may be configured to execute computer-readable instructions stored in a memory (e.g., the memory 1330) to cause the device 1305 to perform various functions (e.g., functions or tasks supporting techniques for performing communications while in a flying state). For example, the device 1305 or a component of the device 1305 may include a processor 1340 and memory 1330 coupled with or to the processor 1340, the processor 1340 and memory 1330 configured to perform various functions described herein.

The inter-station communications manager 1345 may manage communications with other base stations 105, and may include a controller or scheduler for controlling communications with UEs 115 in cooperation with other base stations 105. For example, the inter-station communications manager 1345 may coordinate scheduling for transmissions to UEs 115 for various interference mitigation techniques such as beamforming or joint transmission. In some examples, the inter-station communications manager 1345 may provide an X2 interface within an LTE/LTE-A wireless communications network technology to provide communication between base stations 105.

The communications manager 1320 may support wireless communications at a base station in accordance with examples as disclosed herein. For example, the communications manager 1320 may be configured as or otherwise support a means for receiving a message as part of an emergency communication procedure, the message associated with a UE. The communications manager 1320 may be configured as or otherwise support a means for identifying that the UE meets one or more flying state conditions indicative that the UE is in a flying state. The communications manager 1320 may be configured as or otherwise support a means for participating in the emergency communication procedure while the UE is in the flying state.

By including or configuring the communications manager 1320 in accordance with examples as described herein, the device 1305 may support techniques for improved communication reliability, reduced latency, more efficient utilization of communication resources, and improved coordination between devices.

In some examples, the communications manager 1320 may be configured to perform various operations (e.g., receiving, monitoring, transmitting) using or otherwise in cooperation with the transceiver 1315, the one or more antennas 1325, or any combination thereof. Although the communications manager 1320 is illustrated as a separate component, in some examples, one or more functions described with reference to the communications manager 1320 may be supported by or performed by the processor 1340, the memory 1330, the code 1335, or any combination thereof. For example, the code 1335 may include instructions executable by the processor 1340 to cause the device 1305 to perform various aspects of techniques for performing communications while in a flying state as described herein, or the processor 1340 and the memory 1330 may be otherwise configured to perform or support such operations.

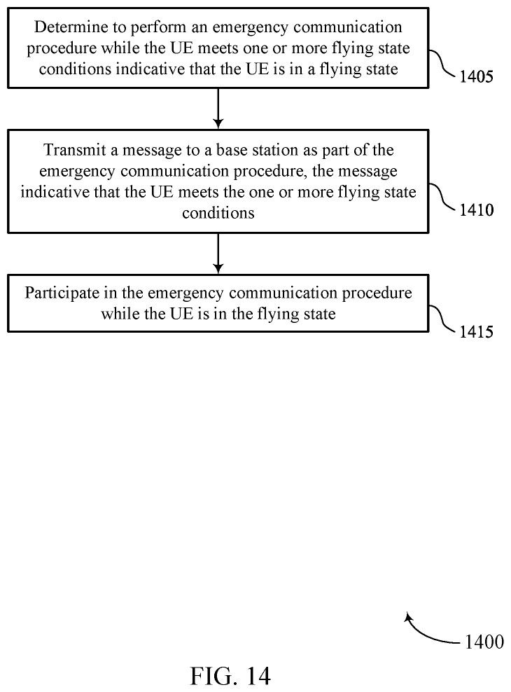

FIG. 14 shows a flowchart illustrating a method 1400 that supports techniques for performing communications while in a flying state in accordance with aspects of the present disclosure. The operations of the method 1400 may be implemented by a UE or its components as described herein. For example, the operations of the method 1400 may be performed by a UE 115 as described with reference to FIGS. 1 through 9. In some examples, a UE may execute a set of instructions to control the functional elements of the UE to perform the described functions. Additionally or alternatively, the UE may perform aspects of the described functions using special-purpose hardware.

At 1405, the method may include determining to perform an emergency communication procedure while the UE meets one or more flying state conditions indicative that the UE is in a flying state. The operations of 1405 may be performed in accordance with examples as disclosed herein. In some examples, aspects of the operations of 1405 may be performed by an emergency determination manager 825 as described with reference to FIG. 8.

At 1410, the method may include transmitting a message to a base station as part of the emergency communication procedure, the message indicative that the UE meets the one or more flying state conditions. The operations of 1410 may be performed in accordance with examples as disclosed herein. In some examples, aspects of the operations of 1410 may be performed by an emergency message transmission manager 830 as described with reference to FIG. 8.

At 1415, the method may include participating in the emergency communication procedure while the UE is in the flying state. The operations of 1415 may be performed in accordance with examples as disclosed herein. In some examples, aspects of the operations of 1415 may be performed by an emergency procedure participation manager 835 as described with reference to FIG. 8.

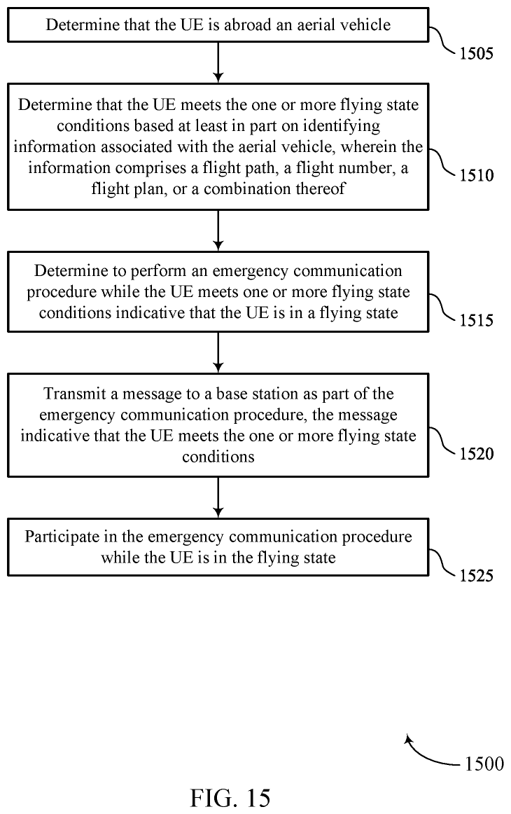

FIG. 15 shows a flowchart illustrating a method 1500 that supports techniques for performing communications while in a flying state in accordance with aspects of the present disclosure. The operations of the method 1500 may be implemented by a UE or its components as described herein. For example, the operations of the method 1500 may be performed by a UE 115 as described with reference to FIGS. 1 through 9. In some examples, a UE may execute a set of instructions to control the functional elements of the UE to perform the described functions. Additionally or alternatively, the UE may perform aspects of the described functions using special-purpose hardware.

At 1505, the method may include determining that the UE is abroad an aerial vehicle. The operations of 1505 may be performed in accordance with examples as disclosed herein. In some examples, aspects of the operations of 1505 may be performed by a flying state determination manager 870 as described with reference to FIG. 8.

At 1510, the method may include determining that the UE meets the one or more flying state conditions based on identifying information associated with the aerial vehicle, where the information includes a flight path, a flight number, a flight plan, or a combination thereof. The operations of 1510 may be performed in accordance with examples as disclosed herein. In some examples, aspects of the operations of 1510 may be performed by a flying state determination manager 870 as described with reference to FIG. 8.

At 1515, the method may include determining to perform an emergency communication procedure while the UE meets one or more flying state conditions indicative that the UE is in a flying state. The operations of 1515 may be performed in accordance with examples as disclosed herein. In some examples, aspects of the operations of 1515 may be performed by an emergency determination manager 825 as described with reference to FIG. 8.

At 1520, the method may include transmitting a message to a base station as part of the emergency communication procedure, the message indicative that the UE meets the one or more flying state conditions. The operations of 1520 may be performed in accordance with examples as disclosed herein. In some examples, aspects of the operations of 1520 may be performed by an emergency message transmission manager 830 as described with reference to FIG. 8.

At 1525, the method may include participating in the emergency communication procedure while the UE is in the flying state. The operations of 1525 may be performed in accordance with examples as disclosed herein. In some examples, aspects of the operations of 1525 may be performed by an emergency procedure participation manager 835 as described with reference to FIG. 8.

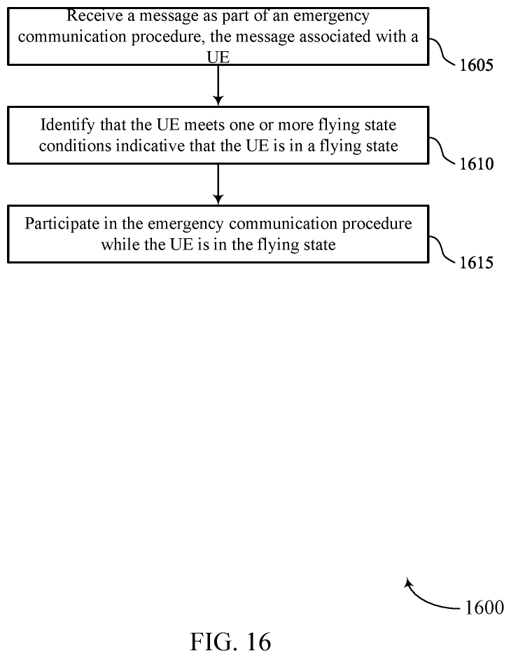

FIG. 16 shows a flowchart illustrating a method 1600 that supports techniques for performing communications while in a flying state in accordance with aspects of the present disclosure. The operations of the method 1600 may be implemented by a base station or its components as described herein. For example, the operations of the method 1600 may be performed by a base station 105 as described with reference to FIGS. 1 through 5 and 10 through 13. In some examples, a base station may execute a set of instructions to control the functional elements of the base station to perform the described functions. Additionally or alternatively, the base station may perform aspects of the described functions using special-purpose hardware.

At 1605, the method may include receiving a message as part of an emergency communication procedure, the message associated with a UE. The operations of 1605 may be performed in accordance with examples as disclosed herein. In some examples, aspects of the operations of 1605 may be performed by an emergency message reception component 1225 as described with reference to FIG. 12.

At 1610, the method may include identifying that the UE meets one or more flying state conditions indicative that the UE is in a flying state. The operations of 1610 may be performed in accordance with examples as disclosed herein. In some examples, aspects of the operations of 1610 may be performed by a flying condition identification manger 1230 as described with reference to FIG. 12.

At 1615, the method may include participating in the emergency communication procedure while the UE is in the flying state. The operations of 1615 may be performed in accordance with examples as disclosed herein. In some examples, aspects of the operations of 1615 may be performed by an emergency procedure participation component 1235 as described with reference to FIG. 12.

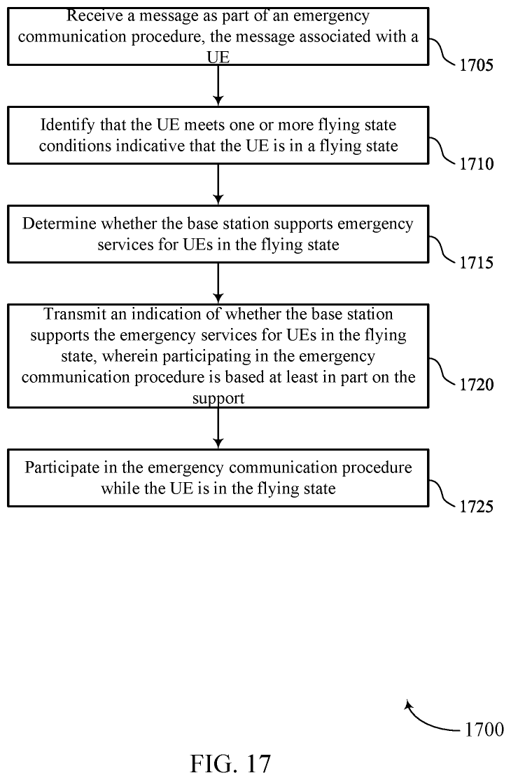

FIG. 17 shows a flowchart illustrating a method 1700 that supports techniques for performing communications while in a flying state in accordance with aspects of the present disclosure. The operations of the method 1700 may be implemented by a base station or its components as described herein. For example, the operations of the method 1700 may be performed by a base station 105 as described with reference to FIGS. 1 through 5 and 10 through 13. In some examples, a base station may execute a set of instructions to control the functional elements of the base station to perform the described functions. Additionally or alternatively, the base station may perform aspects of the described functions using special-purpose hardware.

At 1705, the method may include receiving a message as part of an emergency communication procedure, the message associated with a UE. The operations of 1705 may be performed in accordance with examples as disclosed herein. In some examples, aspects of the operations of 1705 may be performed by an emergency message reception component 1225 as described with reference to FIG. 12.

At 1710, the method may include identifying that the UE meets one or more flying state conditions indicative that the UE is in a flying state. The operations of 1710 may be performed in accordance with examples as disclosed herein. In some examples, aspects of the operations of 1710 may be performed by a flying condition identification manger 1230 as described with reference to FIG. 12.

At 1715, the method may include determining whether the base station supports emergency services for UEs in the flying state. The operations of 1715 may be performed in accordance with examples as disclosed herein. In some examples, aspects of the operations of 1715 may be performed by an emergency support component 1250 as described with reference to FIG. 12.

At 1720, the method may include transmitting an indication of whether the base station supports the emergency services for UEs in the flying state, where participating in the emergency communication procedure is based on the support. The operations of 1720 may be performed in accordance with examples as disclosed herein. In some examples, aspects of the operations of 1720 may be performed by an emergency support component 1250 as described with reference to FIG. 12.

At 1725, the method may include participating in the emergency communication procedure while the UE is in the flying state. The operations of 1725 may be performed in accordance with examples as disclosed herein. In some examples, aspects of the operations of 1725 may be performed by an emergency procedure participation component 1235 as described with reference to FIG. 12.

The following provides an overview of aspects of the present disclosure:

Aspect 1: A method for wireless communications at a UE, comprising: determining to perform an emergency communication procedure while the UE meets one or more flying state conditions indicative that the UE is in a flying state; transmitting a message to a base station as part of the emergency communication procedure, the message indicative that the UE meets the one or more flying state conditions; and participating in the emergency communication procedure while the UE is in the flying state.

Aspect 2: The method of aspect 1, wherein transmitting the message further comprises: transmitting a session initiation protocol message in accordance with a user provided location information procedure, wherein the session initiation protocol message comprises an indication that the UE meets the one or more flying state conditions.

Aspect 3: The method of aspect 2, wherein the session initiation protocol message is an access network information header included in a session initiation protocol.

Aspect 4: The method of any of aspects 1 through 3, wherein transmitting the message further comprises: transmitting an invite to participate in the emergency communication procedure, the invite comprising an indication that the UE meets the one or more flying state conditions.

Aspect 5: The method of any of aspects 1 through 4, wherein transmitting the message further comprises: transmitting the message to a location retrieval function in accordance with a network provided location information procedure.

Aspect 6: The method of any of aspects 1 through 5, wherein transmitting the message further comprises: transmitting a radio resource control session connection request message comprising an indication that the UE meets the one or more flying state conditions based at least in part on determining to perform the emergency communication procedure.

Aspect 7: The method of any of aspects 1 through 6, wherein transmitting the message further comprises: transmitting a non-access stratum packet data network connection message comprising an indication that the UE meets the one or more flying state conditions based at least in part on determining to perform the emergency communication procedure.

Aspect 8: The method of any of aspects 1 through 7, wherein transmitting the message further comprises: transmitting a medium access control (MAC) control element (MAC-CE) message comprising an indication that the UE meets the one or more flying state conditions based at least in part on determining to perform the emergency communication procedure.

Aspect 9: The method of any of aspects 1 through 8, wherein transmitting the message further comprises: determining that the UE is in a limited-service state; and transmitting a registration message based at least in part on determining that the UE is in the limited-service state, wherein the registration message comprises an indication that the UE meets the one or more flying state conditions based at least in part on determining to perform the emergency communication procedure.

Aspect 10: The method of any of aspects 1 through 9, wherein transmitting the message further comprises: determining that the UE lacks an established emergency protocol data unit session; and transmitting a protocol data unit session establishment message comprising a request type, wherein the request type indicates an emergency request and that the UE meets the one or more flying state conditions.

Aspect 11: The method of any of aspects 1 through 10, wherein transmitting the message further comprises: transmitting the message via a frequency band dedicated to aerial vehicles, wherein the frequency band indicates that the UE meets the one or more flying state conditions.

Aspect 12: The method of any of aspects 1 through 11, wherein transmitting the message further comprises: transmitting the message to the base station via an aerial vehicle on which the UE is boarded for a flight.

Aspect 13: The method of any of aspects 1 through 12, further comprising: transmitting an indication of a height of the UE based at least in part on the UE meeting the one or more flying state conditions of the flying state.

Aspect 14: The method of any of aspects 1 through 13, further comprising: transmitting information associated with an aerial vehicle on which the UE is boarded for a flight.

Aspect 15: The method of aspect 14, wherein the information comprises a broadcast remote identifier (BRID) of the aerial vehicle, a location of the aerial vehicle, a flight path, a flight number, a flight plan, or a combination thereof.

Aspect 16: The method of any of aspects 14 through 15, wherein the UE determines the information based at least in part on proximity to the aerial vehicle, a quick response code associated with the aerial vehicle, location services provided by the aerial vehicle, or a combination thereof.

Aspect 17: The method of any of aspects 1 through 16, further comprising: receiving an indication of whether emergency services for UEs in the flying state are supported, wherein participating in the emergency communication procedure is based at least in part on the support indicated.

Aspect 18: The method of aspect 17, wherein the UE receives the indication of support via an Access and Mobility Management Function or a system information block.

Aspect 19: The method of any of aspects 1 through 18, further comprising: receiving, in response to the message and prior to participating in the emergency communication procedure, a request to provide input associated with the flying state.

Aspect 20: The method of any of aspects 1 through 19, further comprising: determining that the UE meets the one or more flying state conditions based at least in part on one or more sensors of the UE.

Aspect 21: The method of any of aspects 1 through 20, further comprising: determining that the UE is abroad an aerial vehicle; and determining that the UE meets the one or more flying state conditions based at least in part on identifying information associated with the aerial vehicle, wherein the information comprises a flight path, a flight number, a flight plan, or a combination thereof.

Aspect 22: The method of any of aspects 1 through 21, further comprising: receiving, from an aerial vehicle on which the UE is boarded for a flight, a broadcast message comprising a flight metric, wherein the flight metric indicates a benchmark of the flight, a flight identifier, flight plans, or a combination thereof; and determining that the UE meets the one or more flying state conditions based at least in part on receiving the broadcast message.

Aspect 23: A method for wireless communications at a base station, comprising: receiving a message as part of an emergency communication procedure, the message associated with a UE; identifying that the UE meets one or more flying state conditions indicative that the UE is in a flying state; and participating in the emergency communication procedure while the UE is in the flying state.

Aspect 24: The method of aspect 23, wherein receiving the message further comprises: receiving a session initiation protocol message in accordance with a user provided location information procedure, where the session initiation protocol message comprises an indication that the UE meets the one or more flying state conditions.

Aspect 25: The method of aspect 24, wherein the session initiation protocol message is an access network information header included in a session initiation protocol.

Aspect 26: The method of any of aspects 23 through 25, wherein receiving the message further comprises: receiving an invite to participate in the emergency communication procedure, the invite comprising an indication that the UE meets the one or more flying state conditions.

Aspect 27: The method of any of aspects 23 through 26, wherein identifying that the UE meets the one or more flying state conditions further comprises: identifying via a location retrieval function in accordance with a network provided location information procedure that the UE meets the one or more flying state conditions.

Aspect 28: The method of any of aspects 23 through 27, wherein identifying that the UE meets the one or more flying state conditions further comprises: identifying via a policy and charging control procedure that the UE meets the one or more flying state conditions.

Aspect 29: The method of any of aspects 23 through 28, wherein receiving the message further comprises: receiving a radio resource control session connection request message comprising an indication that the UE meets the one or more flying state conditions, wherein identifying that the UE meets the one or more flying state conditions is based at least in part on the radio resource control session connection request message.

Aspect 30: The method of any of aspects 23 through 29, wherein receiving the message further comprises: receiving a non-access stratum packet data network connection message comprising an indication that the UE meets the one or more flying state conditions, wherein identifying that the UE meets the one or more flying state conditions is based at least in part on the non-access stratum packet data network connection message.

Aspect 31: The method of any of aspects 23 through 30, wherein receiving the message further comprises: receiving a medium access control (MAC) control element (MAC-CE) message comprising an indication that the UE meets the one or more flying state conditions, wherein identifying that the UE meets the one or more flying state conditions is based at least in part on the MAC-CE message.

Aspect 32: The method of any of aspects 23 through 31, wherein receiving the message further comprises: receiving a registration message comprising an indication that the UE meets the one or more flying state conditions, wherein identifying that the UE meets the one or more flying state conditions is based at least in part on the registration message.

Aspect 33: The method of any of aspects 23 through 32, wherein receiving the message further comprises: receiving a protocol data unit session establishment message comprising a request type, wherein the request type indicates an emergency request and that the UE meets the one or more flying state conditions, wherein identifying that the UE meets the one or more flying state conditions is based at least in part on the protocol data unit session establishment message.

Aspect 34: The method of any of aspects 23 through 33, wherein receiving the message further comprises: receiving the message via a frequency band dedicated to aerial vehicles, wherein identifying that the UE meets the one or more flying state conditions is based at least in part on the frequency band.

Aspect 35: The method of any of aspects 23 through 34, wherein receiving the message further comprises: receiving the message via an aerial vehicle on which the UE is boarded for a flight, wherein participating in the emergency communication procedure is based at least in part on receiving the message via the aerial vehicle.

Aspect 36: The method of any of aspects 23 through 35, further comprising: receiving an indication of a height of the UE, wherein identifying that the UE meets the one or more flying state conditions is based at least in part on the height.

Aspect 37: The method of any of aspects 23 through 36, further comprising: receiving information associated with an aerial vehicle on which the UE is boarded for a flight, wherein the information comprises a broadcast remote identifier (BRID) of the aerial vehicle, a location of the aerial vehicle, a flight path, a flight number, a flight plan, or a combination thereof, wherein identifying that the UE meets the one or more flying state conditions is based at least in part on the information.

Aspect 38: The method of any of aspects 23 through 37, wherein identifying that the UE meets the one or more flying state conditions further comprises: identifying that the UE meets the one or more flying state conditions via UE based location reporting, network based location reporting, or a combination thereof.

Aspect 39: The method of any of aspects 23 through 38, further comprising: determining whether the base station supports emergency services for UEs in the flying state; and transmitting an indication of whether the base station supports the emergency services for UEs in the flying state, wherein participating in the emergency communication procedure is based at least in part on the support.

Aspect 40: The method of aspect 39, wherein the base station transmits the indication via a broadcasted radio resource control message.

Aspect 41: The method of any of aspects 23 through 40, further comprising: transmitting, in response to the message and prior to participating in the emergency communication procedure, a request to provide input associated with the flying state.

Aspect 42: An apparatus for wireless communications at a UE, comprising a processor; and a memory coupled with the processor, wherein the memory comprises instructions executable by the processor to cause the apparatus to perform a method of any of aspects 1 through 22.

Aspect 43: An apparatus for wireless communications at a UE, comprising at least one means for performing a method of any of aspects 1 through 22.

Aspect 44: A non-transitory computer-readable medium storing code for wireless communications at a UE, the code comprising instructions executable by a processor to perform a method of any of aspects 1 through 22.

Aspect 45: An apparatus for wireless communications at a base station, comprising a processor; and a memory coupled with the processor, wherein the memory comprises instructions executable by the processor to cause the apparatus to perform a method of any of aspects 23 through 41.

Aspect 46: An apparatus for wireless communications at a base station, comprising at least one means for performing a method of any of aspects 23 through 41.

Aspect 47: A non-transitory computer-readable medium storing code for wireless communications at a base station, the code comprising instructions executable by a processor to perform a method of any of aspects 23 through 41.

It should be noted that the methods described herein describe possible implementations, and that the operations and the steps may be rearranged or otherwise modified and that other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed with a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor, but in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one place to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

The term “determine” or “determining” encompasses a wide variety of actions and, therefore, “determining” can include calculating, computing, processing, deriving, investigating, looking up (such as via looking up in a table, a database or another data structure), ascertaining and the like. Also, “determining” can include receiving (such as receiving information), accessing (such as accessing data in a memory) and the like. Also, “determining” can include resolving, selecting, choosing, establishing and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A method for wireless communications at a user equipment (UE), comprising:
determining to perform an emergency communication procedure while the UE meets one or more flying state conditions indicative that the UE is in a flying state;
transmitting a message to a base station as part of the emergency communication procedure, the message indicative that the UE meets the one or more flying state conditions; and
participating in the emergency communication procedure while the UE is in the flying state.

2. The method of claim 1, wherein transmitting the message further comprises:
transmitting a session initiation protocol message in accordance with a user provided location information procedure, wherein the session initiation protocol message comprises an indication that the UE meets the one or more flying state conditions.

3. The method of claim 1, wherein transmitting the message further comprises:
transmitting an invite to participate in the emergency communication procedure, the invite comprising an indication that the UE meets the one or more flying state conditions.

4. The method of claim 1, wherein transmitting the message further comprises:
transmitting the message to a location retrieval function in accordance with a network provided location information procedure.

5. The method of claim 1, wherein transmitting the message further comprises:
transmitting a radio resource control session connection request message comprising an indication that the UE meets the one or more flying state conditions based at least in part on determining to perform the emergency communication procedure.

6. The method of claim 1, wherein transmitting the message further comprises:
transmitting a non-access stratum packet data network connection message comprising an indication that the UE meets the one or more flying state conditions based at least in part on determining to perform the emergency communication procedure.

7. The method of claim 1, wherein transmitting the message further comprises:
transmitting a medium access control (MAC) control element (MAC-CE) message comprising an indication that the UE meets the one or more flying state conditions based at least in part on determining to perform the emergency communication procedure.

8. The method of claim 1, wherein transmitting the message further comprises:
determining that the UE is in a limited-service state; and
transmitting a registration message based at least in part on determining that the UE is in the limited-service state, wherein the registration message comprises an indication that the UE meets the one or more flying state conditions based at least in part on determining to perform the emergency communication procedure.

9. The method of claim 1, wherein transmitting the message further comprises:
determining that the UE lacks an established emergency protocol data unit session; and
transmitting a protocol data unit session establishment message comprising a request type, wherein the request type indicates an emergency request and that the UE meets the one or more flying state conditions.

10. The method of claim 1, wherein transmitting the message further comprises:
transmitting the message via a frequency band dedicated to aerial vehicles, wherein the frequency band indicates that the UE meets the one or more flying state conditions.

11. The method of claim 1, wherein transmitting the message further comprises:
transmitting the message to the base station via an aerial vehicle on which the UE is boarded for a flight.

12. The method of claim 1, further comprising:
transmitting an indication of a height of the UE based at least in part on the UE meeting the one or more flying state conditions of the flying state.

13. The method of claim 1, further comprising:
transmitting information associated with an aerial vehicle on which the UE is boarded for a flight.

14. The method of claim 13, wherein the information comprises a broadcast remote identifier (BRID) of the aerial vehicle, a location of the aerial vehicle, a flight path, a flight number, a flight plan, or a combination thereof.

15. An apparatus for wireless communications, comprising:
a processor; and
a memory coupled with the processor, wherein the memory comprises instructions executable by the processor to cause the apparatus to:
determine to perform an emergency communication procedure while a user equipment (UE) meets one or more flying state conditions indicative that the UE is in a flying state;
transmit a message to a base station as part of the emergency communication procedure, the message indicative that the UE meets the one or more flying state conditions; and
participate in the emergency communication procedure while the UE is in the flying state.

16. The apparatus of claim 15, wherein the instructions to transmit the message are further executable by the processor to cause the apparatus to:
transmit a session initiation protocol message in accordance with a user provided location information procedure, wherein the session initiation protocol message comprises an indication that the UE meets the one or more flying state conditions.

17. The apparatus of claim 15, wherein the instructions to transmit the message are further executable by the processor to cause the apparatus to:
transmit an invite to participate in the emergency communication procedure, the invite comprising an indication that the UE meets the one or more flying state conditions.

18. The apparatus of claim 15, wherein the instructions to transmit the message are further executable by the processor to cause the apparatus to:
transmit the message to a location retrieval function in accordance with a network provided location information procedure.

19. The apparatus of claim 15, wherein the instructions to transmit the message are further executable by the processor to cause the apparatus to:
transmit a radio resource control session connection request message comprising an indication that the UE meets the one or more flying state conditions based at least in part on determining to perform the emergency communication procedure.

20. The apparatus of claim 15, wherein the instructions to transmit the message are further executable by the processor to cause the apparatus to:
transmit a non-access stratum packet data network connection message comprising an indication that the UE meets the one or more flying state conditions based at least in part on determining to perform the emergency communication procedure.

21. The apparatus of claim 15, wherein the instructions to transmit the message are further executable by the processor to cause the apparatus to:
transmit a medium access control (MAC) control element (MAC-CE) message comprising an indication that the UE meets the one or more flying state conditions based at least in part on determining to perform the emergency communication procedure.

22. The apparatus of claim 15, wherein the instructions to transmit the message are further executable by the processor to cause the apparatus to:
determine that the UE is in a limited-service state; and
transmit a registration message based at least in part on determining that the UE is in the limited-service state, wherein the registration message comprises an indication that the UE meets the one or more flying state conditions based at least in part on determining to perform the emergency communication procedure.

23. The apparatus of claim 15, wherein the instructions to transmit the message are further executable by the processor to cause the apparatus to:
determine that the UE lacks an established emergency protocol data unit session; and
transmit a protocol data unit session establishment message comprising a request type, wherein the request type indicates an emergency request and that the UE meets the one or more flying state conditions.

24. The apparatus of claim 15, wherein the instructions to transmit the message are further executable by the processor to cause the apparatus to:
transmit the message via a frequency band dedicated to aerial vehicles, wherein the frequency band indicates that the UE meets the one or more flying state conditions.

25. The apparatus of claim 15, wherein the instructions to transmit the message are further executable by the processor to cause the apparatus to:
transmit the message to the base station via an aerial vehicle on which the UE is boarded for a flight.

26. The apparatus of claim 15, wherein the instructions are further executable by the processor to cause the apparatus to:
transmit an indication of a height of the UE based at least in part on the UE meeting the one or more flying state conditions of the flying state.

27. The apparatus of claim 15, wherein the instructions are further executable by the processor to cause the apparatus to:
transmit information associated with an aerial vehicle on which the UE is boarded for a flight.

28. The apparatus of claim 27, wherein the information comprises a broadcast remote identifier (BRID) of the aerial vehicle, a location of the aerial vehicle, a flight path, a flight number, a flight plan, or a combination thereof.

29. An apparatus for wireless communications, comprising:
means for determining to perform an emergency communication procedure while a user equipment (UE) meets one or more flying state conditions indicative that the UE is in a flying state;
means for transmitting a message to a base station as part of the emergency communication procedure, the message indicative that the UE meets the one or more flying state conditions; and
means for participating in the emergency communication procedure while the UE is in the flying state.

30. A non-transitory computer-readable medium storing code for wireless communications, the code comprising instructions executable by a processor to:
determine to perform an emergency communication procedure while a user equipment (UE) meets one or more flying state conditions indicative that the UE is in a flying state;
transmit a message to a base station as part of the emergency communication procedure, the message indicative that the UE meets the one or more flying state conditions; and
participate in the emergency communication procedure while the UE is in the flying state.
